(19) United States
(12) Patent Application Publication
(10) Pub. No.: US 2022/0141756 A1
(43) Pub. Date: May 5, 2022

(54) METHOD AND APPARATUS FOR SYSTEM INFORMATION ACQUISITION VIA UE-TO-NETWORK RELAY IN A WIRELESS COMMUNICATION SYSTEM

(71) Applicant: ASUSTek Computer Inc., Taipei City 112 (TW)

(72) Inventor: Li-Te Pan, Taipei City (TW)

(21) Appl. No.: 17/512,078

(22) Filed: Oct. 27, 2021

Related U.S. Application Data
(60) Provisional application No. 63/107,723, filed on Oct. 30, 2020.
(60) Provisional application No. 63/107,754, filed on Oct. 30, 2020.

(51) Int. Cl. H04W 48/10

(52) U.S. Cl. CPC H04W 48/10; H04W 88/04

(57) ABSTRACT

A method and device are disclosed for a remote User Equipment (UE) to receive system information. In one embodiment, the method includes the remote UE receiving a system information from a network node via a relay UE, wherein a sidelink transmission of the system information is sent with a common Layer-2 Identity (ID) as Destination Layer-2 ID and a Layer-2 ID of the relay UE as Source Layer-2 ID, and wherein the common Layer-2 ID is associated with a purpose of delivering or forwarding the system information from the network node.

### CROSS-REFERENCE TO RELATED APPLICATIONS

The present application claims the benefit of U.S. Provisional Patent Application Ser. Nos. 63/107,723 and 63/107,754 filed on Oct. 30, 2020, the entire disclosures of which are incorporated herein in its entirety by reference.

### FIELD

This disclosure generally relates to wireless communication networks, and more particularly, to a method and apparatus for system information acquisition via UE-to-Network relay in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device are disclosed for a remote User Equipment (UE) to receive system information. In one embodiment, the method includes the remote UE receiving a system information from a network node via a relay UE, wherein a sidelink transmission of the system information is sent with a common Layer-2 Identity (ID) as Destination Layer-2 ID and a Layer-2 ID of the relay UE as Source Layer-2 ID, and wherein the common Layer-2 ID is associated with a purpose of delivering or forwarding the system information from the network node.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of Figure 5.2.2.1-1 of 3GPP TS 38.331 V16.2.0.

FIG. 6 is a reproduction of Figure 5.3.5.1-1 of 3GPP TS 38.331 V16.2.0.

FIG. 7 is a reproduction of Figure 7.3-1 of 3GPP TS 38.300 V16.1.0.

FIG. 8 is a reproduction of Figure 6.7.2.6-1 of 3GPP TR 23.752 V0.5.1.

FIG. 9 is a reproduction of Figure 6.7.2.6-2 of 3GPP TR 23.752 V0.5.1.

FIG. 10 is a reproduction of Figure 6.7.3-1 of 3GPP TR 23.752 V0.5.1.

FIG. 11 is a step flow chart according to one embodiment.

FIG. 12 is a diagram according to one embodiment.

FIG. 13 is a diagram according to one embodiment.

FIG. 14 is a flow chart according to one exemplary embodiment.

FIG. 15 is a flow chart according to one exemplary embodiment.

FIG. 16 is a flow chart according to one exemplary embodiment.

FIG. 17 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 38.331 V16.2.0, “NR; Radio Resource Control (RRC) protocol specification (Release 16)”; TS 38.300 V16.1.0, “NR; NR and NG-RAN Overall Description; Stage 2 (Release 16)”; TR 23.752 V0.5.1, “Study on system enhancement for Proximity based Services (ProSe) in the 5G System (5GS) (Release 17)”; R2-2008922, “On-demand SI Delivery for Remote UE”, CATT. The standards and documents listed above are hereby expressly incorporated by reference in their entirety.

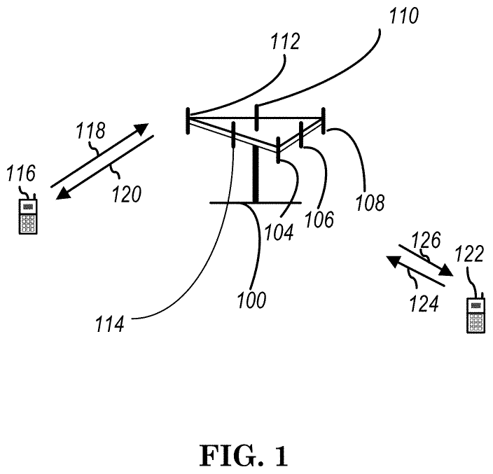

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

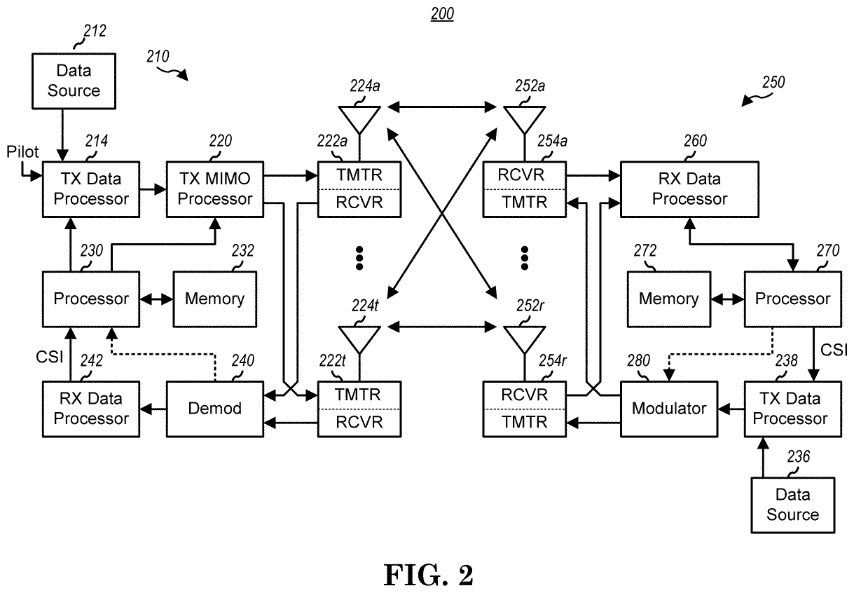

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

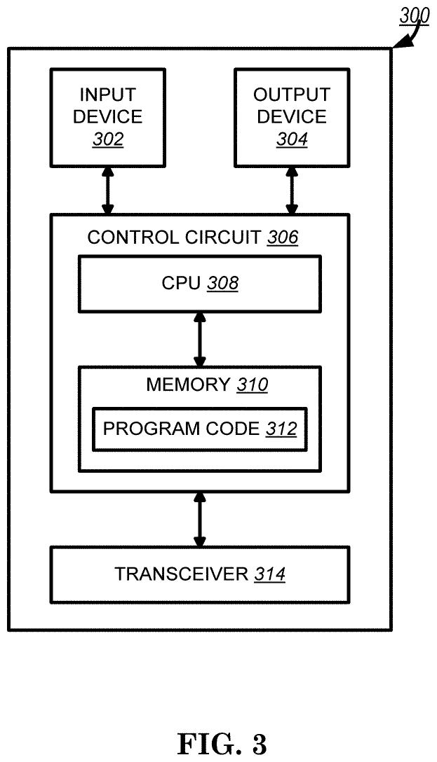

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

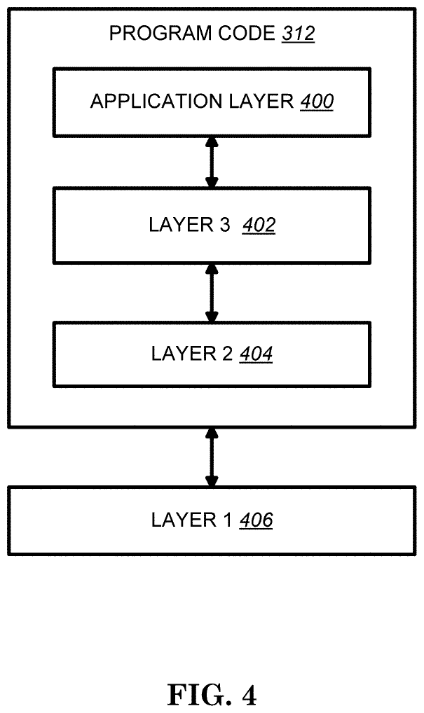

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS 38.331 introduced the following:

### 5.2 System Information

### 5.2.1 Introduction

System Information (SI) is divided into the MIB and a number of SIBs and posSIBs where:
the MIB is always transmitted on the BCH with a periodicity of 80 ms and repetitions made within 80 ms (TS 38.212 [17], clause 7.1) and it includes parameters that are needed to acquire SIB1 from the cell. The first transmission of the MIB is scheduled in subframes as defined in TS 38.213 [13], clause 4.1 and repetitions are scheduled according to the period of SSB;
the SIB1 is transmitted on the DL-SCH with a periodicity of 160 ms and variable transmission repetition periodicity within 160 ms as specified in TS 38.213 [13], clause 13. The default transmission repetition periodicity of SIB1 is 20 ms but the actual transmission repetition periodicity is up to network implementation. For SSB and CORESET multiplexing pattern 1, SIB1 repetition transmission period is 20 ms. For SSB and CORESET multiplexing pattern 2/3, SIB1 transmission repetition period is the same as the SSB period (TS 38.213 [13], clause 13). SIB1 includes information regarding the availability and scheduling (e.g. mapping of SIBs to SI message, periodicity, SI-window size) of other SIBs with an indication whether one or more SIBs are only provided on-demand and, in that case, the configuration needed by the UE to perform the SI request. SIB1 is cell-specific SIB;
SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID;
The mapping of SIBs to SI messages is configured in schedulingInfoList, while the mapping of posSIBs to SI messages is configured in pos-SchedulingInfoList;
For a UE in RRC_CONNECTED, the network can provide system information through dedicated signalling using the RRCReconfiguration message, e.g. if the UE has an active BWP with no common search space configured to monitor system information, paging, or upon request from the UE.
For PSCell and SCells, the network provides the required SI by dedicated signalling, i.e. within an RRCReconfiguration message. Nevertheless, the UE shall acquire MIB of the PSCell to get SFN timing of the SCG (which may be different from MCG). Upon change of relevant SI for SCell, the network releases and adds the concerned SCell. For PSCell, the required SI can only be changed with Reconfiguration with Sync.
NOTE: The physical layer imposes a limit to the maximum size a SIB can take. The maximum SIB1 or SI message size is 2976 bits.

### 5.2.2 System Information Acquisition

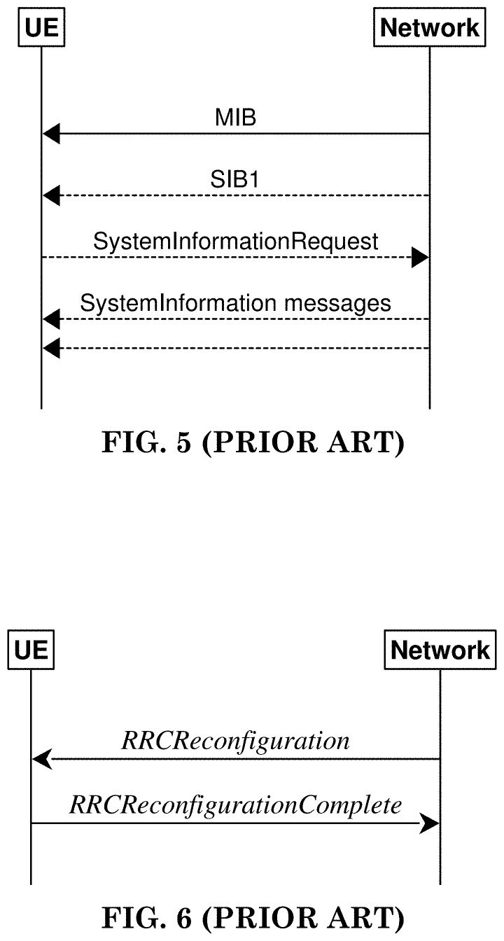

### 5.2.2.1 General UE Requirements

[Figure 5.2.2.1-1 of 3GPP TS 38.331 V16.2.0, Entitled “System Information Acquisition” is Reproduced as FIG. 5]

The UE applies the SI acquisition procedure to acquire the AS, NAS- and positioning assistance data information. The procedure applies to UEs in RRC_IDLE, in RRC_INACTIVE and in RRC_CONNECTED.

The UE in RRC_IDLE and RRC_INACTIVE shall ensure having a valid version of (at least) the MIB, SIB1 through SIB4, SIB5 (if the UE supports E-UTRA), SIB11 (if the UE is configured for idle/inactive measurements), SIB12 (if UE is capable of NR sidelink communication and is configured by upper layers to receive or transmit NR sidelink communication), and SIB13, SIB14 (if UE is capable of V2X sidelink communication and is configured by upper layers to receive or transmit V2X sidelink communication).

### 5.2.2.2 SIB Validity and Need to (Re)-Acquire SIB

### 5.2.2.2.1 SIB Validity

The UE shall apply the SI acquisition procedure as defined in clause 5.2.2.3 upon cell selection (e.g. upon power on), cell-reselection, return from out of coverage, after reconfiguration with sync completion, after entering the network from another RAT, upon receiving an indication that the system information has changed, upon receiving a PWS notification, upon receiving request (e.g., a positioning request) from upper layers; and whenever the UE does not have a valid version of a stored SIB or posSIB or a valid version of a requested SIB.

When the UE acquires a MIB or a SIB1 or an SI message in a serving cell as described in clause 5.2.2.3, and if the UE stores the acquired SIB, then the UE shall store the associated areaScope, if present, the first PLMN-Identity in the PLMN-IdentityInfoList for non-NPN-only cells or the first NPN identity (SNPN identity in case of SNPN, or PNI-NPN identity in case of PNI-NPN) in the NPN-IdentityInfoList for NPN-only cells, the cellIdentity, the systemInformationAreaID, if present, and the valueTag, if present, as indicated in the si-SchedulingInfo for the SIB. The UE may use a valid stored version of the SI except MIB, SIB1, SIB6, SIB7 or SIB8 e.g. after cell re-selection, upon return from out of coverage or after the reception of SI change indication. The value tag for posSIB is optionally provided in LPP signalling [49].
NOTE: The storage and management of the stored SIBs in addition to the SIBs valid for the current serving cell is left to UE implementation.

The UE shall:
1> delete any stored version of a SIB after 3 hours from the moment it was successfully confirmed as valid;
1> for each stored version of a SIB:
   2> if the areaScope is associated and its value for the stored version of the SIB is the same as the value received in the si-SchedulingInfo for that SIB from the serving cell:
      3> if the UE is NPN capable and the cell is an NPN-only cell and the first NPN identity included in the NPN-IdentityInfoList, the systemInformationAreaID and the valueTag that are included in the si-SchedulingInfo for the SIB received from the serving cell are identical to the NPN identity, the systemInformationAreaID and the valueTag associated with the stored version of that SIB:
         4> consider the stored SIB as valid for the cell;
      3> else if the first PLMN-Identity included in the PLMN-IdentityInfoList, the systemInformationAreaID and the valueTag that are included in the si-SchedulingInfo for the SIB received from the serving cell are identical to the PLMN-Identity, the systemInformationAreaID and the valueTag associated with the stored version of that SIB:
         4> consider the stored SIB as valid for the cell;
   2> if the areaScope is not present for the stored version of the SIB and the areaScope value is not included in the si-SchedulingInfo for that SIB from the serving cell:
      3> if the UE is NPN capable and the cell is an NPN-only cell and the first NPN identity in the NPN-IdentityInfoList, the cellIdentity and valueTag that are included in the si-SchedulingInfo for the SIB received from the serving cell are identical to the NPN identity, the cellIdentity and the valueTag associated with the stored version of that SIB:
         4> consider the stored SIB as valid for the cell;
      3> else if the first PLMN-Identity in the PLMN-IdentityInfoList, the cellIdentity and valueTag that are included in the si-SchedulingInfo for the SIB received from the serving cell are identical to the PLMN-Identity, the cellIdentity and the valueTag associated with the stored version of that SIB:
         4> consider the stored SIB as valid for the cell;

### 5.2.2.2.2 SI Change Indication and PWS Notification

A modification period is used, i.e. updated SI message (other than SI message for ETWS, CMAS and positioning assistance data) is broadcasted in the modification period following the one where SI change indication is transmitted. The modification period boundaries are defined by SFN values for which SFN mod m=0, where m is the number of radio frames comprising the modification period. The modification period is configured by system information. The UE receives indications about SI modifications and/or PWS notifications using Short Message transmitted with P-RNTI over DCI (see clause 6.5). Repetitions of SI change indication may occur within preceding modification period. SI change indication is not applicable for SI messages containing posSIBs.

UEs in RRC_IDLE or in RRC_INACTIVE shall monitor for SI change indication in its own paging occasion every DRX cycle. UEs in RRC_CONNECTED shall monitor for SI change indication in any paging occasion at least once per modification period if the UE is provided with common search space on the active BWP to monitor paging, as specified in TS 38.213 [13], clause 13. ETWS or CMAS capable UEs in RRC_IDLE or in RRC_INACTIVE shall monitor for indications about PWS notification in its own paging occasion every DRX cycle. ETWS or CMAS capable UEs in RRC_CONNECTED shall monitor for indication about PWS notification in any paging occasion at least once every defaultPagingCycle if the UE is provided with common search space on the active BWP to monitor paging.

For Short Message reception in a paging occasion, the UE monitors the PDCCH monitoring occasion(s) for paging as specified in TS 38.304 [20] and TS 38.213 [13].

If the UE receives a Short Message, the UE shall:
1> if the UE is ETWS capable or CMAS capable, the etwsAndCmasIndication bit of Short Message is set, and the UE is provided with searchSpaceOtherSystemInformation on the active BWP or the initial BWP:
   2> immediately re-acquire the SIB1;
   2> if the UE is ETWS capable and si-SchedulingInfo includes scheduling information for SIB6:
      3> acquire SIB6, as specified in sub-clause 5.2.2.3.2, immediately;
   2> if the UE is ETWS capable and si-SchedulingInfo includes scheduling information for SIB7:
      3> acquire SIB7, as specified in sub-clause 5.2.2.3.2, immediately;
   2> if the UE is CMAS capable and si-SchedulingInfo includes scheduling information for SIB&
      3> acquire SIB8, as specified in sub-clause 5.2.2.3.2, immediately;
NOTE: In case SIB6, SIB7, or SIB8 overlap with a measurement gap it is left to UE implementation how to immediately acquire SIB6, SIB7, or SIB8.
1> if the systemInfoModification bit of Short Message is set:
   2> apply the SI acquisition procedure as defined in sub-clause 5.2.2.3 from the start of the next modification period.

### 5.2.2.3 Acquisition of System Information

### 5.2.2.3.1 Acquisition of MIB and SIB1

The UE shall:
1> apply the specified BCCH configuration defined in 9.1.1.1;
1> if the UE is in RRC_IDLE or in RRC_INACTIVE; or
1> if the UE is in RRC_CONNECTED while T311 is running:
   2> acquire the MIB, which is scheduled as specified in TS 38.213 [13];
   2> if the UE is unable to acquire the MIB;
      3> perform the actions as specified in clause 5.2.2.5;
   2> else:
      3> perform the actions specified in clause 5.2.2.4.1.
1> if the UE is in RRC_CONNECTED with an active BWP with common search space configured by searchSpaceSIB1 and pagingSearchSpace and has received an indication about change of system information; or
1> if the UE is in RRC_CONNECTED with an active BWP with common search space configured by searchSpaceSIB1 and pagingSearchSpace and the UE has not stored a valid version of a SIB, in accordance with sub-clause 5.2.2.2.1, of one or several required SIB(s), in accordance with sub-clause 5.2.2.1, and, UE has not acquired SIB1 in current modification period or if requested by upper layers; or
1> if the UE is in RRC_IDLE or in RRC_INACTIVE; or
1> if the UE is in RRC_CONNECTED while T311 is running:
   2> if ssb-SubcarrierOffset indicates SIB1 is transmitted in the cell (TS 38.213 [13]) and if SIB1 acquisition is required for the UE:
      3> acquire the SIB1, which is scheduled as specified in TS 38.213 [13];
      3> if the UE is unable to acquire the SIB1:
         4> perform the actions as specified in clause 5.2.2.5;
      3> else:
         4> upon acquiring SIB1, perform the actions specified in clause 5.2.2.4.2.
   2> else if SIB1 acquisition is required for the UE and ssb-SubcarrierOffset indicates that SIB1 is not scheduled in the cell:
      3> perform the actions as specified in clause 5.2.2.5.
NOTE: The UE in RRC_CONNECTED is only required to acquire broadcasted SIB1 if the UE can acquire it without disrupting unicast data reception, i.e. the broadcast and unicast beams are quasi co-located.
   [ . . . ]

### 5.2.2.4 Actions Upon Receipt of System Information

### 5.2.2.4.1 Actions Upon Reception of the MIB

Upon receiving the MIB the UE shall:
1> store the acquired MIB;
1> if the UE is in RRC_IDLE or in RRC_INACTIVE, or if the UE is in RRC_CONNECTED while T311 is running:
   2> if the cellBarred in the acquired MIB is set to barred:
      3> consider the cell as barred in accordance with TS 38.304 [20];
      3> if intraFreqReselection is set to notAllowed; and
      3> if the cell operates in licensed spectrum or the cell belongs to a PLMN which is indicated as being equivalent to the registered PLMN or the cell belongs to the registered SNPN of the UE:
         4> consider cell re-selection to other cells on the same frequency as the barred cell as not allowed, as specified in TS 38.304 [20].
      3> else:
         4> consider cell re-selection to other cells on the same frequency as the barred cell as allowed, as specified in TS 38.304 [20].
   2> else:
      3> apply the received systemFrameNumber, pdcch-ConfigSIB1, subCarrierSpacingCommon, ssb-SubcarrierOffset and dmrs-TypeA-Position.

### 5.2.2.4.2 Actions Upon Reception of the SIB1

Upon receiving the SIB1 the UE shall:
1> store the acquired SIB1;
1> if the cellAccessRelatedInfo contains an entry with the PLMN-Identity of the selected PLMN:
   2> in the remainder of the procedures use plmn-IdentityList, trackingAreaCode, and cellIdentity for the cell as received in the corresponding PLMN-IdentityInfo containing the selected PLMN;
1> if the cellAccessRelatedInfo contains an entry of npn-IdentityInfoList with the NPN identity of the selected PLMN or SNPN:
   2> in the remainder of the procedures use npn-IdentityList, trackingAreaCode, and cellIdentity for the cell as received in the corresponding entry of npn-IdentityInfoList containing the selected PLMN or SNPN;
1> if in RRC_CONNECTED while T311 is not running:
   2> disregard the frequencyBandList, if received, while in RRC_CONNECTED;
   2> forward the cellIdentity to upper layers;
   2> forward the trackingAreaCode to upper layers;
   2> forward the received posSIB-MappingInfo to upper layers, if included;
   2> apply the configuration included in the servingCellConfigCommon;
   2> if the UE has a stored valid version of a SIB or posSIB, in accordance with sub-clause 5.2.2.2.1, that the UE requires to operate within the cell in accordance with sub-clause 5.2.2.1:
      3> use the stored version of the required SIB or posSIB;
   2> else:
      3> acquire the required SIB or posSIB requested by upper layer as defined in sub-clause 5.2.2.3.5;
NOTE: Void.
1> else:
   2> if the UE supports one or more of the frequency bands indicated in the frequencyBandList for downlink for TDD, or one or more of the frequency bands indicated in the frequencyBandList for uplink for FDD, and they are not downlink only bands, and
   2> if the UE supports at least one additionalSpectrumEmission in the NR-NS-PmaxList for a supported band in the downlink for TDD, or a supported band in uplink for FDD, and
   2> if the UE supports an uplink channel bandwidth with a maximum transmission bandwidth configuration (see TS 38.101-1 [15] and TS 38.101-2 [39]) which
      is smaller than or equal to the carrierBandwidth (indicated in uplinkConfigCommon for the SCS of the initial uplink BWP), and which
      is wider than or equal to the bandwidth of the initial uplink BWP, and
   2> if the UE supports a downlink channel bandwidth with a maximum transmission bandwidth configuration (see TS 38.101-1 [15] and TS 38.101-2 [39]) which
      is smaller than or equal to the carrierBandwidth (indicated in downlinkConfigCommon for the SCS of the initial downlink BWP), and which
      is wider than or equal to the bandwidth of the initial downlink BWP:
      3> if trackingAreaCode is not provided for the selected PLMN nor the registered PLMN nor PLMN of the equivalent PLMN list:
         4> consider the cell as barred in accordance with TS 38.304 [20];
         4> if intraFreqReselection is set to notAllowed:
         5> consider cell re-selection to other cells on the same frequency as the barred cell as not allowed, as specified in TS 38.304 [20];
         4> else:
         5> consider cell re-selection to other cells on the same frequency as the barred cell as allowed, as specified in TS 38.304 [20];
      3> else if UE is IAB-MT and if iab-Support is not provided for the selected PLMN nor the registered PLMN nor PLMN of the equivalent PLMN list nor the selected SNPN nor the registered SNPN:
         4> consider the cell as barred for IAB-MT in accordance with TS 38.304 [20];
      3> else:
         4> apply a supported uplink channel bandwidth with a maximum transmission bandwidth which
         is contained within the carrierBandwidth indicated in uplinkConfigCommon for the SCS of the initial uplink BWP, and which
         is wider than or equal to the bandwidth of the initial BWP for the uplink;
         4> apply a supported downlink channel bandwidth with a maximum transmission bandwidth which
         is contained within the carrierBandwidth indicated in downlinkConfigCommon for the SCS of the initial downlink BWP, and which
         is wider than or equal to the bandwidth of the initial BWP for the downlink;
         4> select the first frequency band in the frequencyBandList, for FDD from frequencyBandList for uplink, or for TDD from frequencyBandList for downlink, which the UE supports and for which the UE supports at least one of the additionalSpectrumEmission values in nr-NS-PmaxList, if present;
         4> forward the cellIdentity to upper layers;
         4> forward the trackingAreaCode to upper layers;
         4> forward the received posSIB-MappingInfo to upper layers, if included;
         4> forward the PLMN identity or SNPN identity or PNI-NPN identity to upper layers;
         4> if in RRC_INACTIVE and the forwarded information does not trigger message transmission by upper layers:
         5> if the serving cell does not belong to the configured ran-NotificationAreaInfo:
         6> initiate an RNA update as specified in 5.3.13.8;
         4> forward the ims-EmergencySupport to upper layers, if present;
         4> forward the eCallOverIMS-Support to upper layers, if present;
         4> forward the uac-AccessCategory1-SelectionAssistanceInfo to upper layers, if present;
         4> apply the configuration included in the servingCellConfigCommon;
         4> apply the specified PCCH configuration defined in 9.1.1.3;
         4> if the UE has a stored valid version of a SIB, in accordance with sub-clause 5.2.2.2.1, that the UE requires to operate within the cell in accordance with sub-clause 5.2.2.1:
         5> use the stored version of the required SIB;
         4> if the UE has not stored a valid version of a SIB, in accordance with sub-clause 5.2.2.2.1, of one or several required SIB(s), in accordance with sub-clause 5.2.2.1:
         5> for the SI message(s) that, according to the si-SchedulingInfo, contain at least one required SIB and for which si-BroadcastStatus is set to broadcasting:
         6> acquire the SI message(s) as defined in sub-clause 5.2.2.3.2;
         5> for the SI message(s) that, according to the si-SchedulingInfo, contain at least one required SIB and for which si-BroadcastStatus is set to notBroadcasting:
         6> trigger a request to acquire the SI message(s) as defined in sub-clause 5.2.2.3.3;
         4> if the UE has received request from upper layers:
         5> for the SI message(s) that, according to the posSI-SchedulingInfo, contain at least one requested posSIB and for which posSI-BroadcastStatus is set to broadcasting:
         6> acquire the SI message(s) as defined in sub-clause 5.2.2.3.2;
         5> for the SI message(s) that, according to the posSI-SchedulingInfo, contain at least one requested posSIB for which posSI-BroadcastStatus is set to notBroadcasting:
         6> trigger a request to acquire the SI message(s) as defined in sub-clause 5.2.2.3.3a;
         4> apply the first listed additionalSpectrumEmission which it supports among the values included in NR-NS-PmaxList within frequencyBandList in uplinkConfigCommon for FDD or in downlinkConfigCommon for TDD;
         4> if the additionalPmax is present in the same entry of the selected additionalSpectrumEmission within NR-NS-PmaxList:
         5> apply the additionalPmax for UL;
         4> else:
         5> apply the p-Max in uplinkConfigCommon for UL;
         4> if supplementaryUplink is present in servingCellConfigCommon; and
         4> if the UE supports one or more of the frequency bands indicated in the frequencyBandList of supplementary uplink; and
         4> if the UE supports at least one additionalSpectrumEmission in the NR-NS-PmaxList for a supported supplementary uplink band; and
         4> if the UE supports an uplink channel bandwidth with a maximum transmission bandwith configuration (see TS 38.101-1 [15] and TS 38.101-2 [39]) which
         is smaller than or equal to the carrierBandwidth (indicated in supplementaryUplink for the SCS of the initial uplink BWP), and which
         is wider than or equal to the bandwidth of the initial uplink BWP of the SUL:
         5> consider supplementary uplink as configured in the serving cell;
         5> select the first frequency band in the frequencyBandList of supplementary uplink which the UE supports and for which the UE supports at least one of the additionalSpectrumEmission values in nr-NS-PmaxList, if present;
         5> apply a supported supplementary uplink channel bandwidth with a maximum transmission bandwidth which
         is contained within the carrierBandwidth (indicated in supplementaryUplink for the SCS of the initial uplink BWP), and which
         is wider than or equal to the bandwidth of the initial BWP of the SUL;
         5> apply the first listed additionalSpectrumEmission which it supports among the values included in NR-NS-PmaxList within frequencyBandList for the supplementaryUplink;
         5> if the additionalPmax is present in the same entry of the selected additionalSpectrumEmission within NR-NS-PmaxList for the supplementaryUplink:
         6> apply the additionalPmax in supplementaryUplink for SUL;
         5> else:
         6> apply the p-Max in supplementaryUplink for SUL;
   2> else:
      3> consider the cell as barred in accordance with TS 38.304 [20]; and
      3> perform barring as if intraFreqReselection is set to notAllowed;
         [ . . . ]

### 5.2.2.5 Essential System Information Missing

The UE shall:
1> if in RRC_IDLE or in RRC_INACTIVE or in RRC_CONNECTED while T311 is running:
   2> if the UE is unable to acquire the MIB:
      3> consider the cell as barred in accordance with TS 38.304 [20]; and
      3> perform barring as if intraFreqReselection is set to allowed;
   2> else if the UE is unable to acquire the SIB1:
      3> consider the cell as barred in accordance with TS 38.304 [20].
      3> if the cell operates in licensed spectrum and intraFreqReselection in MIB is set to notAllowed:
         4> consider cell re-selection to other cells on the same frequency as the barred cell as not allowed, as specified in TS 38.304 [20].
      3> else:
         4> consider cell re-selection to other cells on the same frequency as the barred cell as allowed, as specified in TS 38.304 [20].
            [ . . . ]

### 5.3.5 RRC Reconfiguration

### 5.3.5.1 General

[Figure 5.3.5.1-1 of 3GPP TS 38.331 V16.2.0, Entitled “RRC Reconfiguration, Successful”, is Reproduced as FIG. 6]

[ . . . ]

### 5.3.5.3 Reception of an RRCReconfiguration by the UE

The UE shall perform the following actions upon reception of the RRCReconfiguration, or upon execution of the conditional reconfiguration (CHO or CPC):

[ . . . ]
1> if the RRCReconfiguration message includes the dedicatedSystemInformationDelivery:
   2> perform the action upon reception of System Information as specified in 5.2.2.4;
      [ . . . ]

### 6.2.1 General Message Structure

[ . . . ]

UL-CCCH-Message

The UL-CCCH-Message class is the set of 48-bits RRC messages that may be sent from the UE to the Network on the uplink CCCH logical channel.

--- ASQ1START
--- TAG-UL-CCCH-MESSAGE-START

| | |
|---|---|
| UL-CCCH-Message: := | SEQUENCE { |
| message | UL-CCCH-MessageType |
| } | |
| UL-CCCH-MessageType ::= | CHOICE { |
| c1 | CHOICE { |
| ... | |
| rrcSystemInfoRequest | RRCSystemInfoRequest |
| }, | |
| messageClassExtension | SEQUENCE { } |
| } | |

--- TAG-UL-CCCH-MESSAGE-STOP
--- ASN1STOP
[...]

UL-DCCH-Message

The UL-DCCH-Message class is the set of RRC messages that may be sent from the UE to the network on the uplink DCCH logical channel.

--- ASN1START
--- TAG-UL-DCCH-MESSAGE-START

| | |
|---|---|
| UL-DCCH-Message ::= | SEQUENCE { |
| message | UL-DCCH-MessageType |
| } | |
| UL-DCCH-MessageType ::= | CHOICE { |
| c1 | CHOICE { |
| ... | |
| }, | |
| messageClassExtension | CHOICE { |
| c2 | CHOICE { |
| ... | |
| dedicatedSIBRequest-r16 | DedicatedSIBRequest-r16, |
| ... | |
| }, | |

messageClassExtensionFuture-r16 SEQUENCE { }

}
}

--- TAG-UL-DCCH-MESSAGE-STOP
--- ASN1STOP
[...]

BCCH-BCH-Message

The BCCH-BCH-Message class is the set of RRC messages that may be sent from the network to the UE via BCH on the BCCH logical channel.

--- ASN1START
--- TAG-BCCH-BCH-MESSAGE-START

| | |
|---|---|
| BCCH-BCH-Message ::= | SEQUENCE { |
| message | BCCH-BCH-MessageType |
| } | |
| BCCH-BCH-MessageType ::= | CHOICE { |
| mib | MIB, |
| messageClassExtension | SEQUENCE { } |
| } | |

--- TAG-BCCH-BCH-Message-STOP
--- ASN1STOP
[...]

BCCH-DL-SCH-Message

The BCCH-DL-SCH-Message class is the set of RRC messages that may be sent from the network to the UE via DL-SCH on the BCCH logical channel.

--- ASQ1START
--- TAG-BCCM-DL-SCH-MESSAGE-START

| | |
|---|---|
| BCCH-DL-SCH-Message ::= | SEQUENCE { |
| message | BCCH-DL-SCH-MessageType |
| } | |
| BCCH-DL-SCH-MessageType ::= | CHOICE { |
| c1 | CHOICE { |
| systemInformation | SystemInformation, |
| systemInformationBlockType1 | SIB1 |
| }, | |
| messageClassExtension | SEQUENCE { } |

}
--- TAG-BCCM-DL-SCH-MESSAGE-STOP
--- ASN1STOP
[...]

### 6.2.2 Message Definitions

[ . . . ]

RRCSystemInfoRequest

The RRCSystemInfoRequest message is used to request SI message(s) required by the UE as specified in clause 5.2.2.3.3.
Signalling radio bearer: SRB0
RLC-SAP: TM
Logical channel: CCCH
Direction: UE to Network

RRCSysteminfoRequest message

--- ASQ1START
--- TAG-PRCS7STEMIOFOREQUEST-STAPT

| | |
|---|---|
| RRCSystemInfoRequest ::= | SEQUENCE { |
| criticalExtensions | CHOICE { |
| rrcSystemInfoRequest | RRCSystemInfoRequest-IEs, |
| criticalExtensionsFuture-r16 | CHOICE { |
| rrcPosSystemInfoRequest-r16 | RRC-PosSystemInfoRequest-r16-IEs, |
| criticalExtensionsFuture | SEQUENCE { } |

```
    }
  }
}
RRCSystemInfoRequest-IEs ::= SEQUENCE {
```

| | |
|---|---|
| requested-SI-List | BIT STRING (SIZE (maxSI-Message) ), --32bits |
| spare | BIT STRING (SIZE (12) ) |
| } | |

RRC-PosSystemInfoRequest-r16-IEs ::= SEQUENCE {

| | |
|---|---|
| requestedPosSI-List | BIT STRING (SIZE (maxSI-Message) ), --32bits |
| spare | BIT STRING (SIZE (11) ) |
| } | |

--- TAG-PRCS7STEMIOFOREQUEST-STOP
--- ASN1STOP

RRCSystemInfoRequest-IEs field descriptions

requested-SI-List
Contains a list of requested SI messages. According to the order of entry in the list of SI
messages configured by schedulingInfoList in si-SchedulingInfo in SIB1, first bit corresponds to
first/leftmost listed SI message, second bit corresponds to second listed SI message, and so on.
requestedPosSI-List
Contains a list of requested SI messages. According to the order of entry in the list of SI
messages configured by posSchedulingInfoList in posSI-SchedulingInfo in SIB1, first bit
corresponds to first/leftmost listed SI message, second bit corresponds to second listed SI
message, and so on.
[ . . . ]

DedicatedSIBRequest

The DedicatedSIBRequest message is used to request SIB(s) required by the UE in RRC_CONNECTED as specified in clause 5.2.2.3.5.
Signalling radio bearer: SRB1
RLC-SAP: AM
Logical channel: DCCH
Direction: UE to Network

DedicatedSIBRequest message

--- ASQ1START
--- TAG-DEDICATEDSIEPEQUEST-START

| | |
|---|---|
| DedicatedSIBRequest-r16 ::= | SEQUENCE { |
| criticalExtensions | CHOICE { |
| dedicatedSIBRequest-r16 | DedicatedSIBRequest-r16-IEs, |
| criticalExtensionsFuture | SEQUENCE { } |
| } | |
| } | |
| DedicatedSIBRequest-r16-IEs ::= | SEQUENCE { |
| onDemandSIB-RequestList-r16 | SEQUENCE { |
| requestedSIB-List-r16 | SEQUENCE (SIZE (1..maxOnDemandSIB-r16) ) OF SIB-ReqInfo- |

r16 OPTIONAL,

| | |
|---|---|
| requestedPosSIB-List-r16 | SEQUENCE (SIZE (1..maxOnDemandPosSIB-r16) ) OF PosSIB- |

ReqInfo-r16 OPTIONAL,
} OPTIONAL,

| | |
|---|---|
| lateNonCriticalExtension | OCTET STRING OPTIONAL, |
| nonCriticalExtension | SEQUENCE { } OPTIONAL |

}

| | |
|---|---|
| SIB-ReqInfo-r16 ::= | ENUMERATED { sib12, sib13, sib14, spare5, spare4, spare3, |

spare2, spare1 }

| PosSIB-ReqInfo-r16 ::= | SEQUENCE { | |
|---|---|---|
| gnss-id-r16 | GNSS-ID-r16 | OPTIONAL, |
| sbas-id-r16 | SBAS-ID-r16 | OPTIONAL, |

| | |
|---|---|
| posSibType-r16 | ENUERATED { posSibType1-1, posSibType1-2, posSibType1-3, |

```
posSibType1-4, posSibType1-5, posSibType1-6,
                                                  posSibType1-7, posSibType1-8, posSibType2-1,
posSibType2-2, posSibType2-3, posSibType2-4,
                                                  posSibType2-5, posSibType2-6, posSibType2-7,
posSibType2-8, posSibType2-9, posSibType2-10,
                                                  posSibType2-11, posSibType2-12, posSibType2-13,
posSibType2-14, posSibType2-15,
                                                  posSibType2-16, posSibType2-17, posSibType2-18,
posSibType2-19, posSibType2-20,
                                                  posSibType2-21, posSibType2-22, posSibType2-23,
posSibType3-1, posSibType4-1,
                                                  posSibType5-1, posSibType6-1, posSibType6-2,
posSibType6-3,... }
}
--- TAG-DEDICATEDSIBREQUEST-STOP
--- ASN1STOP
```

DedicatedSIBRequest field descriptions

requestedSIB-List
Contains a list of SIB(s) the UE requests while in RRC_CONNECTED.
requestedPosSIB-List
Contains a list of posSIB(s) the UE requests while in RRC_CONNECTED.
[ . . . ]

RRCReconfiguration

The RRCReconfiguration message is the command to modify an RRC connection. It may convey information for measurement configuration, mobility control, radio resource configuration (including RBs, MAC main configuration and physical channel configuration) and AS security configuration.
Signalling radio bearer: SRB1 or SRB3
RLC-SAP: AM
Logical channel: DCCH
Direction: Network to UE

RRCReconfiguration message

--- ASN1STAPT
--- TAG-RECRECONFIGURATION-START
...

| | |
|---|---|
| RRCReconfiguration-v1530-IEs ::= | SEQUENCE { |
| ... | |
| dedicatedSIB1-Delivery | OCTET STRING (CONTAINING SIB1) |

OPTIONAL, ---NEED N

| | |
|---|---|
| dedicatedSystemInformationDelivery | OCTET STRING (CONTAINING SystemInformation) |

OPTIONAL, --NEED N
...
}
...

RRCReconfiguration-IEs field descriptions

dedicatedSIB1-Delivery
This field is used to transfer SIB1 to the UE. The field has the same values as the corresponding
configuration in servingCellConfigCommon.
dedicatedSystemInformationDelivery
This field is used to transfer SIB6, SIB7, SIB8 to the UE with an active BWP with no common
serach space configured. For UEs in RRC_CONNECTED, this field is used to transfer the SIBs
requested on-demand.
[ . . . ]

SystemInformation

The SystemInformation message is used to convey one or more System Information Blocks or Positioning System Information Blocks. All the SIB8 or posSIBs included are transmitted with the same periodicity.
Signalling radio bearer: N/A
RLC-SAP: TM
Logical channels: BCCH
Direction: Network to UE

Systeminformation message

--- ASN1START
--- TAG-SYSTEMINFORMATION-START

| | |
|---|---|
| SystemInformation ::= | SEQUENCE { |
| criticalExtensions | CHOICE {{ |
| systemInformation | SystemInformation-IEs, |
| criticalExtensionsFuture-r16 | CHOICE { |
| posSystemInformation-r16 | PosSystemInformation-r16-IEs, |
| criticalExtensionsFuture | SEQUENCE { } |
| } | |
| } | |
| } | |
| SystemInformation-IEs ::= | SEQUENCE { |
| sib-TypeAndInfo | SEQUENCE (SIZE (1..maxSIB) ) OF CHOICE { |
| sib2 | SIB2, |
| sib3 | SIB3, |
| sib 4 | SIB4, |
| sib5 | SIB5, |
| sib6 | SIB6, |
| sib7 | SIB7, |
| sib8 | SIB8, |
| sib9 | SIB9, |
| sib10-v1610 | SIB10-r16, |
| sibll-v1610 | SIB11-r16, |
| sib12-v1610 | SIB12 r16, |
| sib13-v1610 | SIB13 r16, |
| sib14-v1610 | SIB14-r16 |
| }, | |
| lateNonCriticalExtension | OCTET STRING OPTIONAL, |
| nonCriticalExtension | SEQUENCE { } OPTIONAL, |

}
--- TAG-SYSTEMINFORMATION-STOP
--- ASN1STOP

3GPP TS 38.300 introduced the following:

### 7.3 System Information Handling

### 7.3.1 Overview

System Information (SI) consists of a MIB and a number of SIBs, which are divided into Minimum SI and Other SI:
Minimum SI comprises basic information required for initial access and information for acquiring any other SI. Minimum SI consists of:
   MIB contains cell barred status information and essential physical layer information of the cell required to receive further system information, e.g. CORESET #0 configuration. MIB is periodically broadcast on BCH.
   SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.
Other SI encompasses all SIBs not broadcast in the Minimum SI. Those SIBs can either be periodically broadcast on DL-SCH, broadcast on-demand on DL-SCH (i.e. upon request from UEs in RRC_IDLE or RRC_INACTIVE), or RRC_CONNECTED, or sent in a dedicated manner on DL-SCH to UEs in RRC_CONNECTED (i.e., upon request from UEs in RRC_CONNECTED or when the UE has an active BWP with no common search space configured). Other SI consists of:
   SIB2 contains cell re-selection information, mainly related to the serving cell;
   SIB3 contains information about the serving frequency and intra-frequency neighbouring cells relevant for cell re-selection (including cell re-selection parameters common for a frequency as well as cell specific re-selection parameters);
   SIB4 contains information about other NR frequencies and inter-frequency neighbouring cells relevant for cell re-selection (including cell re-selection parameters common for a frequency as well as cell specific re-selection parameters);
   SIB5 contains information about E-UTRA frequencies and E-UTRA neighbouring cells relevant for cell re-selection (including cell re-selection parameters common for a frequency as well as cell specific re-selection parameters);
   SIB6 contains an ETWS primary notification;
   SIB7 contains an ETWS secondary notification;
   SIB8 contains a CMAS warning notification;
   SIB9 contains information related to GPS time and Coordinated Universal Time (UTC). For sidelink, Other SI also includes:
   SIB12 contains information related to NR sidelink communication;
   SIB13 contains information related to SystemInformationBlockType21 for V2X sidelink communication as specified in TS 36.331 clause 5.2.2.28 [29];
   SIB14 contains information related to SystemInformationBlockType26 for V2X sidelink communication as specified in TS 36.331 clause 5.2.2.33 [29].

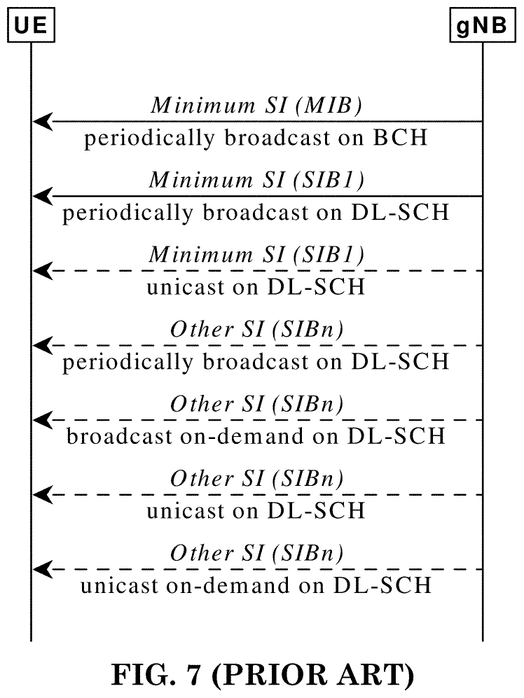

Figure 7.3-1 below summarises System Information provisioning.

[Figure 7.3-1 of 3GPP TS 38.300 V16.1.0, entitled “System Information Provisioning”, is reproduced as FIG. 7]

For a cell/frequency that is considered for camping by the UE, the UE is not required to acquire the contents of the minimum SI of that cell/frequency from another cell/frequency layer. This does not preclude the case that the UE applies stored SI from previously visited cell(s).

If the UE cannot determine the full contents of the minimum SI of a cell by receiving from that cell, the UE shall consider that cell as barred.

In case of BA, the UE only acquires SI on the active BWP.

### 7.3.2 Scheduling

The MIB is mapped on the BCCH and carried on BCH while all other SI messages are mapped on the BCCH, where they are dynamically carried on DL-SCH. The scheduling of SI messages part of Other SI is indicated by SIB1.

For UEs in RRC_IDLE and RRC_INACTIVE, a request for Other SI triggers a random access procedure (see clause 9.2.6) where MSG3 includes the SI request message unless the requested SI is associated to a subset of the PRACH resources, in which case MSG1 is used for indication of the requested Other SI. When MSG1 is used, the minimum granularity of the request is one SI message (i.e. a set of SIBs), one RACH preamble and/or PRACH resource can be used to request multiple SI messages and the gNB acknowledges the request in MSG2. When MSG 3 is used, the gNB acknowledges the request in MSG4.

For UEs in RRC_CONNECTED, a request for Other SI may be sent to the network in a dedicated manner (i.e., via UL-DCCH) and the granularity of the request is one SIB. The gNB may respond with an RRCReconfiguration including the requested SIB(s). It is a network choice to decide which requested SIBs are delivered in a dedicated or broadcasted manner.

The Other SI may be broadcast at a configurable periodicity and for a certain duration. The Other SI may also be broadcast when it is requested by UE in RRC_IDLE/RRC_INACTIVE.

For a UE to be allowed to camp on a cell it must have acquired the contents of the Minimum SI from that cell. There may be cells in the system that do not broadcast the Minimum SI and where the UE therefore cannot camp.

### 7.3.3 SI Modification

Change of system information (other than for ETWS/CMAS, see clause 16.4) only occurs at specific radio frames, i.e. the concept of a modification period is used. System information may be transmitted a number of times with the same content within a modification period, as defined by its scheduling. The modification period is configured by system information.

When the network changes (some of the) system information, it first notifies the UEs about this change, i.e. this may be done throughout a modification period. In the next modification period, the network transmits the updated system information. Upon receiving a change notification, the UE acquires the new system information from the start of the next modification period. The UE applies the previously acquired system information until the UE acquires the new system information.

3GPP TR 23.752 introduced the following:

### 6.7 Solution #7: Indirect Communication Via Layer 2 UE-to-Network Relay UE

### 6.7.1 Introduction

The solution addresses the following aspect highlighted in key issue #3 (Support UE-to-Network Relay UE):
How to transfer data between the Remote UE and the network over the UE-to-Network Relay UE.

The solution proposes a protocol architecture to support a Layer 2 UE-to-Network Relay UE (see Annex A).

This solution works only for NR/5GC network relays. It does not apply when the UE-to-Network Relay UE is out of coverage of NR/5GC.

### 6.7.2 Functional Description

### 6.7.2.1 General

In this clause, the protocol architecture supporting a L2 UE-to-Network Relay UE is provided. The L2 UE-to-Network Relay UE provides forwarding functionality that can relay any type of traffic over the PC5 link.

The L2 UE-to-Network Relay UE provides the functionality to support connectivity to the 5GS for Remote UEs. A UE is considered to be a Remote UE if it has successfully established a PC5 link to the L2 UE-to-Network Relay UE. A Remote UE can be located within NG-RAN coverage or outside of NG-RAN coverage.

### 6.7.2.2 Control and User Plane Protocols

The control and user plane protocols stacks are based on the architectural reference model described in Annex A.

### 6.7.2.3 Network Selection

Network selection comprises PLMN selection and access network selection. Access network selection for a Remote UE comprises UE-to-Network relay discovery and selection. The Remote UE performs PLMN selection in accordance with the PLMN selected by the UE-to-Network Relay. The Relay UE provides serving PLMN information and other PLMNs information in System Information to the Remote UE in order to perform PLMN selection during discovery.
Editor's note: It is FFS which and how many PLMNs a L2 UE-to-Network Relay is expected to support and advertise. For instance whether it is only its registered PLMN, its registered PLMN and equivalent to the registered PLMN or it can be (hard) configured to include any PLMN similar to MOCN configuration.

The Remote UE and UE-to-Network Relay UE are by definition served by the same NG-RAN.

### 6.7.2.4 Authorization and Provisioning

In order to enable a (Remote) UE out of coverage to gain connectivity to the network, it is important to allow such UE by means of (pre)configuration to discover potential UE-to-Network Relay UEs through which it could gain access to the 5GS. To do so:

Parameters for UE-to-Network Relay UE discovery and for communication over NR PC5 may be made available to the Remote UE as follows:
Pre-configured in the ME and/or configured in the UICC;
Provided or updated by the PCF to the UE in the serving PLMN.

It is also important that a UE be authorized to operate as a UE-to-Network Relay UE. A UE may only operate as a UE-to-Network Relay UE when served by the network.

Parameters for a UE to operate as a UE-to-Network Relay UE, for discovery of Remote UEs over NR PC5 and for communication over NR PC5 may be made available to the UE as follows:
Pre-configured in the ME and/or configured in the UICC;
Provided or updated by the PCF to the UE in the serving PLMN.

It should be possible for the HPLMN PCF to provide authorization for a UE to operate as a Remote UE or as a UE-to-Network Relay UE on a per PLMN basis. It should also be possible for the Serving PLMN to provide/revoke such authorization in which case it shall override any corresponding information provided by the HPLMN.

PCF based service authorization and provisioning solution for Layer-2 UE-to-Network Relay could reuse Solution #35.

### 6.7.2.5 Registration and Connection Management

### 6.7.2.5.1 Registration Management

Registration Management for the UE-to-Network Relay UE follows the principles and procedures defined in TS 23.501 [6] and TS 23.502 [8]. The UE-to-Network Relay is served by a first AMF.

Registration Management for the Remote UE follows the principles and procedures defined in TS 23.501 [6] and TS 23.502 [8]. The Remote UE is served by a second AMF that may or may not be the same as the first AMF.
NOTE: The UE is authorized to act as a UE-to-Network Relay only if the Network (including RAN/CN) does not restrict it, e.g. authorization, Unified Access Control, and Remote UE and UE-to-Network Relay are in the same rPLMN or ePLMN.

### 6.7.2.5.2 Connection Management

Connection Management for the UE-to-Network Relay UE follows at least the principles and procedures defined in TS 23.501 [6] and TS 23.502 [8].

Connection Management for the Remote UE follows the principles and procedures defined in TS 23.501 [6] and TS 23.502 [8].

The UE-to-Network Relay may only relay data/signaling for the Remote UE(s) when the UE-to-Network Relay is in CM-CONNECTED/RRC Connected states. If the UE-to-Network Relay in CM_IDLE state receives the PC5 connection request from the Remote UE for relay, the UE-to-Network Relay shall trigger Service Request procedure to enter CM_CONNECTED state before relaying the signalling.
If any Remote UE connected to the UE-to-Network Relay UE is CM-CONNECTED, the UE-to-Network Relay UE should remain CM-CONNECTED state.
If all Remote UEs connected to the UE-to-Network Relay UE enter CM-IDLE, the UE-to-Network Relay UE may enter CM-IDLE state.
NOTE: The applied state needs to be coordinated and confirmed by RAN WG2. Impact on RRC Inactive will also be studied by RAN WG2.

When Remote UE is CM-IDLE or CM-CONNECTED, Relay UE and Remote UE keeps the PC5 link. For paging Remote UE, the concluded solution in clause 6.6.2 of TR 23.733 [26] can be reused based on the assumption that option 2 of TR 36.746 [27] is adopted by RAN WG2.
Editor's note: Whether paging option 2 of TR 36.746 [27] will be adopted for 5G ProSe by RAN WG2 needs to be confirmed by RAN group.

### 6.7.2.5.3 NAS Level Congestion Control

The UE-to-Network Relay may experience NAS level congestion control, as specified in clause 5.19.7 of TS 23.501 [6].

When NAS Mobility Management congestion control is activated, i.e. the UE-to-Network Relay receives Mobility Management back-off timer from the AMF, the UE-to-Network Relay is not able to properly serve the Remote UE after the UE-to-Network Relay enters CM_IDLE state. In that case, the UE-to-Network Relay needs to inform the Remote UE that there is a Mobility Management back-off timer running at the UE-to-Network Relay, so that the Remote UE is able to (re)select to another UE-to-Network Relay.

The Remote UE may also subject to NAS level congestion control. The existing behavior defined in TS 23.501 [6] shall apply.

### 6.7.2.6 QoS

As shown in Annex A, the NAS endpoints between a Remote UE and the network are as currently specified such that the operation via a UE-to-Network Relay UE should be transparent to the network NAS, with the exception of authorization/provisioning identified in clause 6.7.2.4.

This means that the 5GS flow-based QoS concept in particular should be reused between the Remote UE and the network, with necessary adaptation over the radio interface i.e. PC5 (for the Remote UE and UE-to-Network Relay UE) and Uu (for the UE-to-Network Relay UE). RAN performs QoS enforcement for PC5 interface and Uu interfaces when it gets QoS profile from the CN. For example, RAN performs QoS enforcement with AS layer configuration with necessary adaptation over PC5 interface and Uu interface. In other words, QoS flows established between the network and the Remote UE will be mapped to PC5 “radio bearers” seen by the Remote UE and to normal Uu radio bearers seen by the network, whereby the UE-to-Network Relay UE performs the necessary adaptation between Uu and PC5.
Editor's note: How to perform AS layer configuration for PC5 interface and Uu interface depends on RAN.

### 6.7.2.7 Mobility

### 6.7.2.7.1 Mobility Restrictions

The Remote UE is expected to operate within the boundaries of the Mobility Restrictions applicable to the UE to Network Relay UE.

Mobility restriction in CM-IDLE state is executed by the UE based on the information received from the network. For the UE-to-Network Relay case, the Remote UE may not obtain the mobility restrictions related information if Remote UE is out of coverage. The Remote UE can get the mobility restrictions related information, e.g., tracking area, from the Relay UE, and the Remote UE itself performs network selection and access control in CM_IDLE state based on the received information.

### RAT Restriction:

If Remote UE is restricted to use some RAT in a PLMN, the Remote UE is not allowed to access via UE-to-Network Relay using that RAT in that PLMN. If UE-to-Network Relay is restricted to use some RAT in a PLMN, the UE-to-Network Relay is not allowed to perform the Relay operation using that RAT in that PLMN.

Forbidden Area:
If UE-to-Network Relay is in Forbidden Area, it is not allowed to perform the Relay operation. If the UE-to-Network Relay operates in a Forbidden Area of the Remote UE, the Remote UE is not allowed to access the network via this UE-to-Network Relay.
A UE-to-Network Relay shall indicate to Remote UEs the Tracking Area of the cell to which the UE-to-Network Relay is connected. The indication is provided during discovery.

### Service Area Restriction: Allowed Area, Non-Allowed Area

Allowed Area applies as is for a UE-to-Network Relay and Remote UE. A UE-to-Network Relay (resp. Remote UE) is allowed to initiate communication with the network (resp. with the network via a UE-to-Network Relay) as allowed by subscription.
A UE-to-Network Relay may only perform UE-to-Network Relay operation in an Allowed Area.
Non-allowed Area applies as is for a UE-to-Network Relay and Remote UE. The UE (UE-to-Network Relay or Remote UE) and the network are not allowed to initiate Service Request or SM signalling to obtain user services (both in CM-IDLE and in CM-CONNECTED states). RM procedures for non-3GPP access aspects are not applicable for the Remote UE.
When the UE-to-Network Relay UE enters a non-allowed Area and the UE-to-Network Relay cannot provide relay service, it may release the PC5 unicast connection with a cause code informing the remote UE of UE-to-Network Relay in Non-allowed area.
NOTE 1: The above bullet on Service Area Restriction changing due to UE-to-Network Relay's mobility will be evaluated separately from other parts of solution #7.

### Core Network Type Restriction:

The CN type restriction applies as is to a UE-to-Network Relay and Remote UE. A UE-to-Network Relay or Remote UE may only operate as such when not restricted to use 5GC.

### Closed Access Group Information:

A UE permitted (resp. not permitted) to access a CAG cell is implicitly permitted (resp. not permitted) to access this CAG cell as a Remote UE via a UE-to-Network Relay. The Allowed CAG list and CAG-only indication of a UE apply to this UE when it is a Remote UE.
A UE permitted (resp. not permitted) to access a CAG cell is implicitly permitted (resp. not permitted) to access this CAG cell as a UE-to-Network Relay. The Allowed CAG list and CAG-only indication of a UE apply to this UE when it operates as a UE-to-Network Relay.
A UE-to-Network Relay shall indicate to Remote UEs the CAG identifiers of the CAG the UE-to-Network Relay is permitted to access via the cell to which it is connected. The indication is provided during discovery.
A UE-to-Network Relay shall provide its CAG-only indication to Remote UE if the UE-to-Network Relay is only permitted to access a CAG cell. The CAG identifiers and CAG-only indication are provided to Remote UEs for UE-to-Network Relay selection during discovery procedure.
A UE-to-Network Relay may send an update of the CAG identifiers and CAG-only indication to the remote UEs due to UE-to-Network Relay's mobility or UE-to-Network Relay's configuration change, e.g. UE Configuration Update procedure described in TS 23.502 [8] in clause 4.2.4.2. In this case, the Remote UE may tear down the PC5 connection and re-select another UE-to-Network Relay if the Remote UE determines that it is not allowed anymore to access the network via the current UE-to-Network Relay or may re-select the same UE-to-Network Relay if it is still allowed considering the new configuration.
NOTE 2: The above two bullets on CAG identifiers changing and CAG-only indication will be evaluated separately from other part of solution 7.

### 6.7.2.7.2 Other

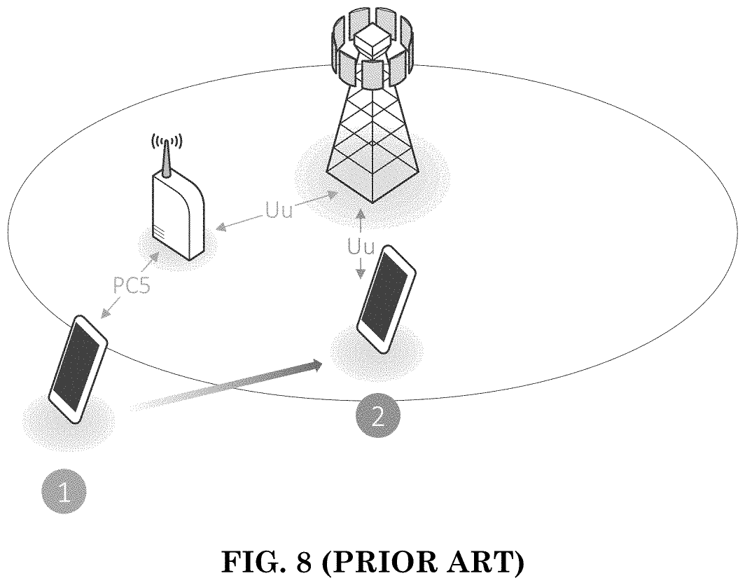

Mobility of a Remote UE within an NG-RAN node will be handled by the NG-RAN and the UE-to-Network Relay, allowing the Remote UE to maintain service when changing from a direct network connection to an indirect network connection (i.e. via L2 UE-to-Network Relay UE) and vice-versa without 5GC involvement.

[Figure 6.7.2.6-1 of 3GPP TR 23.752 V0.5.1, Entitled “Intra-NG-RAN Mobility (No 5GC Involvement)”, is Reproduced as FIG. 8]

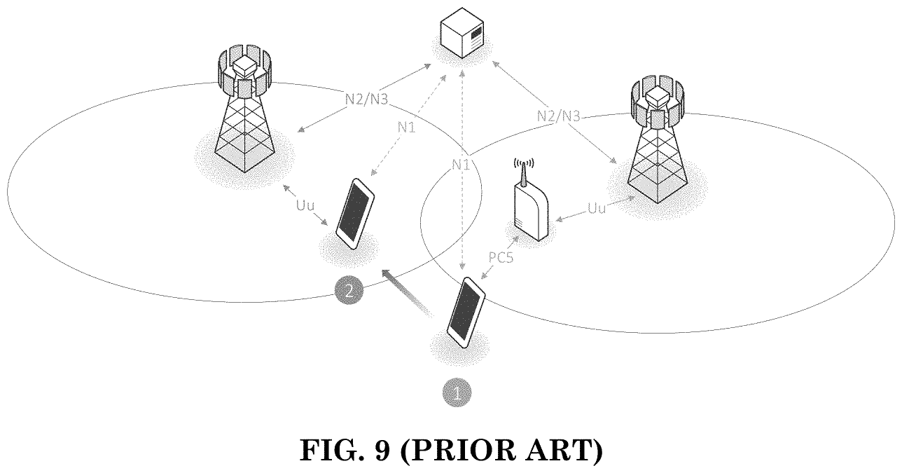

Inter-NG-RAN mobility is depicted below. Mobility is expected to be possible with no impact on NAS and most impact on lower layers i.e. RAN WG2.

[Figure 6.7.2.6-2 of 3GPP TR 23.752 V0.5.1, Entitled “Inter-NG-RAN Mobility”, is Reproduced as FIG. 9]

### 6.7.2.8 Security

Security (confidentiality and integrity protection) is enforced at the PDCP layer between the endpoints at the Remote UE and the gNB. The PDCP traffic is relayed securely over two links, one between the Remote UE and the UE-to-Network Relay UE and the other between the UE-to-Network Relay UE to the gNB without exposing any of the Remote UE's plaintext data to the UE-to-Network Relay.

UP integrity protection is separated for direct PC5 communication and indirect communication.

For indirect communication, the NG-RAN and Remote UE are the nodes that enforce the UP integrity protection for data transmission between NG-RAN and Remote UE.

For direct PC5 communication, the UE-to-Network Relay UE and Remote UE are the nodes that enforce the UP integrity protection for data transmission between UE-to-Network Relay UE and Remote UE.
NOTE: Further analysis of security requirements will be done in SA WG3.

### 6.7.2.9 UE-to-Network Relay Discovery and Selection

Model A and Model B can be applied for Layer-2 UE-to-Network Relay discovery. The detailed UE-to-Network Relay discovery and selection solution for Layer-2 UE-to-Network Relay could reuse Solution #19, with the difference that slicing and DNN information do not need to be considered. In addition, mobility restrictions related information such as CAG cell and TA may to be included in the discovery message.
Editor's note: How the Relay discovery can be performed with the PLMN selection for the Remote UE will be addressed in separate solution for KI #3.

### 6.7.2.10 Path Selection

For initial access, Remote UE may perform communication path selection between direct Uu path and indirect Uu path based on the link quality and the configured threshold (pre-configured or provided by NG-RAN). For example, if Uu link quality exceeds configured threshold, the direct Uu path is selected. Otherwise, the indirect Uu path is selected by performing the UE-to-Network Relay discovery and selection.

For path switch case, NG-RAN may perform communication path selection based on the signal level/quality of different paths, which may be based on the path switch solution.
Editor's note: The final solution should be coordinated with RAN WG, and the specific radio criteria and corresponding thresholds are subject to RAN WG definition.

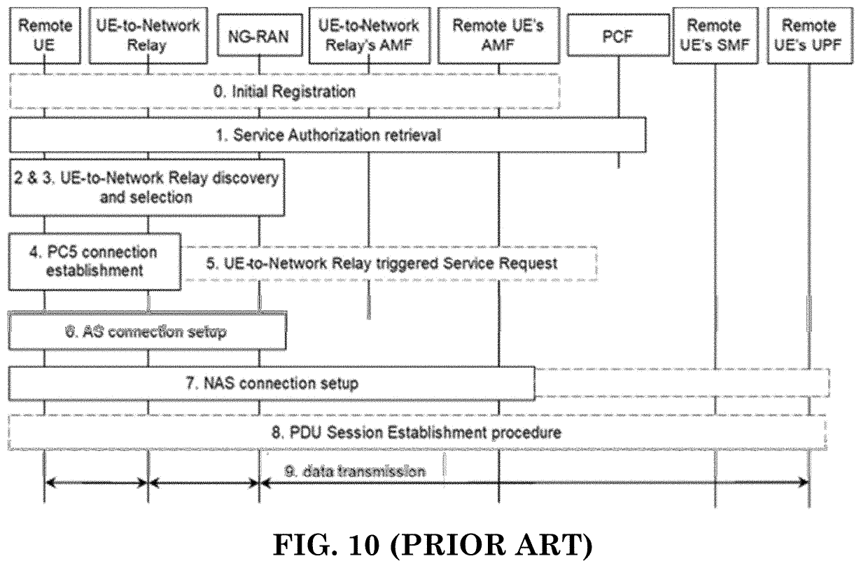

### 6.7.3 Procedures

[Figure 6.7.3-1 of 3GPP TR 23.752 V0.5.1, Entitled “Connection Establishment for Indirect Communication Via UE-to-Network Relay UE”, is Reproduced as FIG. 10]
0. If in coverage, the Remote UE and UE-to-Network Relay UE may independently perform the initial registration to the network according to registration procedures in TS 23.502 [8]. The allocated 5G GUTI of the Remote UE is maintained when later NAS signalling between Remote UE and Network is exchanged via the UE-to-Network Relay UE.
NOTE 1: The current procedures shown here assume a single hop relay.
1. If in coverage, the Remote UE and UE-to-Network Relay UE independently get the service authorization for indirect communication from the network. Service authorization and parameters provisioning for UE-to-Network Relay operation are performed for the UE-to-Network Relay UE and Remote UE as specified in clause 6.7.2.4.
   If the Remote UE is not in coverage, the pre-configured information will be used. If needed, the PCF could update the authorization information after step 7.

If Remote UE has not performed the Initial Registration, the Remote UE can perform the Initial Registration via the Indirect Network Communication in step 7.
2-3. The Remote UE and UE-to-Network Relay UE perform UE-to-Network Relay UE discovery
and selection. Relay UE can perform UE-to-Network Relay discovery in both CM_IDLE and CM_CM-CONNECTED.

For details of UE-to-Network Relay discovery and selection for Layer-2 UE-to-Network Relay see clause 6.7.2.9 and Solution #19, Solution #41.
4. Remote UE initiates a one-to-one communication connection with the selected UE-to-Network Relay UE over PC5 using the procedure as described in TS 23.287 [5].
5. If the UE-to-Network Relay UE is in CM_IDLE state, triggered by the communication request received from the Remote UE, the UE-to-Network Relay UE sends a Service Request message to its serving AMF.
   The Relay's AMF may perform authentication of the UE-to-Network Relay UE based on NAS message validation and if needed the AMF will check the subscription data.

How to keep the Relay UE in CM_CONNECTED state is proposed in the clause 6.7.2.5.2.
6. Remote UE sends AS messages to the NG-RAN via the UE-to-NW Relay UE, to establish an AS Connection with the same NG-RAN serving the Relay UE.
7. Remote UE sends a NAS message to the serving AMF. The NAS message is encapsulated in an RRC message that is sent over PC5 to the UE-to-Network Relay UE, and the UE-to-Network Relay UE forwards the message to the NG-RAN. The NG-RAN derives Remote UE's serving AMF and forwards the NAS message to this AMF.
   If Remote UE has not performed the initial registration to the network in step 0, the NAS message is initial registration message. Otherwise, the NAS message is either a service request message, or a mobility or periodic Registration message.
Editor's note: How the UE-to-Network Relay UE forwards the message to the NG-RAN depends on RAN specified L2 relay method.
   If the Remote UE performs initial registration via the UE-to-Network relay, the Remote UE's serving AMF may perform authentication of the Remote UE based on NAS message validation and if needed the Remote UE's AMF checks the subscription data.
   For service request case, User Plane connection for PDU Sessions can also be activated. The other steps follow the clause 4.2.3.2 in TS 23.502 [8].
8. Remote UE may trigger the PDU Session Establishment procedure as defined in clause 4.3.2.2 of TS 23.502 [8]. Remote UE allowed PDU session related attributes while operating via the UE-to-NW Relay UE are provided during the registration procedure or through pre-configuration as described in step 0.
9. The data is transmitted between Remote UE and UPF via UE-to-Network Relay UE and NG-RAN. The UE-to-Network Relay UE forwards all the data messages between the Remote UE and NG-RAN using RAN specified L2 relay method.
NOTE 2: If the UE-to-Network Relay disconnects, the NG-RAN will trigger the AN release procedure of the Remote UE and the Remote UE goes to CM-IDLE.

### 6.7.4 Impacts on Services, Entities and Interfaces

The solution has impacts in the following entities:

### AMF:

Not initiate the release of the signalling connection based on authorization of Relay UE.

### RAN:

Needs to support L2 relay functionality for forwarding the signalling and user data of the Remote UE.
(If paging option 2 of TR 36.746 [27] is confirmed by RAN WG2), RAN needs to handle paging request for Remote UE when the Relay UE is CM-CONNECTED.

### UE-to-Network Relay UE:

Needs to support L2 relay functionality for forwarding the signalling and user data between the Remote UE and RAN.
(If paging option 2 of TR 36.746 [27] is confirmed by RAN WG2) need to monitor multiple paging occasions for itself and the remote UEs.
   [ . . . ]

3GPP R2-2008922 introduced the following:

### 1. Introduction

After RAN2#111-e meeting, the long email discussion “[Post111-e][627][Relay] Remaining issues on L2 architecture” was discussed [1]. The proposals of on-demand SI delivery for Remote UE were as below:

Proposal-30: agree the following description for L2 UE-to-NW relay (also reflected
by TP)
Relay UE can support the relaying of the system information to the Remote
UE(s) and what system information can be relayed to Remote UEs can be
discussed at normative phase.
Proposal-31: agree the following description for L2 UE-to-NW relay (also reflected
by TP)
Relay UE can forward the received system information to Remote UEs via
broadcast or groupcast.
Proposal-32 [Easy]: agree the following description for L2 UE-to-NW relay (also
reflected by TP)
Relay UE can forward the system information to Remote UE via dedicated
PC5-RRC signaling and the detailed mechanisms of PC5-RRC signaling design
can be discussed in WI stage.
Proposal-33: agree the following on-demand SI delivery principles for Remote UE
for L2 UE-to-NW relay (also reflected by TP)
On-demand SI request is supported for Remote UE for all RRC states
(Idle/Inactive/Connected state).
Only Msg3 based on-demand SI request is supported for Remote UE during
Idle or Inactive mode; For connected Remote UE, only on-demand SIB
request (i.e. dedicatedSIBRequest) is supported as Rel-16.
The legacy Uu RRC procedure is reused to support the Remote UE's on-
demand SI request.
On-demand SI delivery is supported for the Remote UE(s) regardless of out-
of-coverage or in-coverage, when connected with Relay UE.
Proposal-34: RAN2 further discuss PC5-RRC message based SIB notification from
Remote UE to the Relay UE for L2 UE-to-UE Relay at WI phase.

In this contribution, we discuss on-demand SI delivery principles for Remote UE.

### 2. Discussion

In [1], on-demand SI principles for remote UE are proposed as below:

Proposal-33: agree the following on-demand SI delivery principles for Remote UE
for L2 UE-to-NW relay (also reflected by TP)
On-demand SI request is supported for Remote UE for all RRC states
(Idle/Inactive/Connected state).
Only Msg3 based on-demand SI request is supported for Remote UE during
Idle or Inactive mode; For connected Remote UE, only on-demand SIB
request (i.e. dedicatedSIBRequest) is supported as Rel-16.
The legacy Uu RRC procedure is reused to support the Remote UE's on-
demand SI request.
On-demand SI delivery is supported for the Remote UE(s) regardless of out-
of-coverage or in-coverage, when connected with Relay UE.

In Uu interface, UE supports on-demand SI for all RRC states. The remote UE accesses to network via U2N relay should be treated as a normal UE as much as possible. Therefore, the first principle is reasonable.

Although when the remote UE is in coverage, it can acquire the SI from gNB directly. However, the remote UE and the relay UE may be in different cells. The remote UE can acquire the SIBs of the relay UE's serving cell via on-demand SI manner. Besides this case, on-demand SI for remote UE can also be used for OOC remote UE. Therefore, the fourth principle is reasonable.

For the second and third principles, they should be discussed further.

The Uu on-demand SI procedures for RRC_Connected and for Idle/Inactive states are different. Hence, on-demand SI principles for remote UE should be discussed for RRC_Connected and for Idle/Inactive separately.

In rel-16, the on-demand SI procedure in RRC_Connected is supported. The dedicatedSIBRequest message is introduced to request SIB(s) required by the UE in RRC_Connected. Upon receiving the on-demand SIB request by the UE, the network responds with either an RRCReconfiguration message that includes the requested SIBs (if these are send via dedicated signalling) or broadcast. For the case that the network responds with an RRCReconfiguration message, the on-demand SI procedure in RRC_Connected can be reused for connected remote UE. If the network responds with broadcast, the situation is similar to Idle/Inactive remote UE.

Proposal 1: For Connected remote UE, on-demand SI in RRC_Connected that both SIB request and respond via dedicated signaling can be reused.

For Idle/Inactive remote UE, both Msg1 and Msg3 based on-demand SI can't work.

For Msg1 based on-demand SI, since Uu preamble of remote UE can't be relayed, it can't be used for remote UE.

For Msg3 based on-demand SI, it also can't be used for remote UE, even though RRCSystemInfoRequest message of the remote UE can be relayed to gNB using the same scheme as the first RRC message for connection establishment from Remote UE with gNB. The reasons are as below:

### 1. The Remote UE Can't Receive Msg4.

The remote UE has not TEMPORARY_C-RNTI since Msg1 and Msg2 procedure are absent before Msg3. Hence, the relay UE doesn't know whether the PDCCH is addressed to the remote UE. Further, the UE Contention Resolution Identity MAC CE is a MAC PDU, the relay UE can't relay Uu MAC CE to the remote UE since MAC layer isn't end-to-end between remote UE and gNB.

### 2. The Remote UE Can't Acquire the Requested SI Message.

It is obviously that the remote UE can't monitor the updated SIB1 and receive the SI message by itself. If the remote UE want to let the relay UE to do it, it shall inform the whole information (including request SI) to relay UE, i.e. on-demand SI message shall be introduced in PC5 between remote UE and relay UE. Since the PC5 on-demand SI procedure should be introduced, it is unnecessary to specify that the SIB acquire procedure in Uu is requested by remote UE. In other word, it isn't the legacy Msg3 based on-demand SI. The on-demand SI for remote UE is divided to 2 parts; one is on-demand SI procedure between remote UE and relay UE, the other one is SI acquire procedure of relay UE.
   Observation 1: Both Msg1 and Msg3 based on-demand SI can't be used for remote UE.
   Proposal 2: On-demand SI for remote UE should be divided into 2 parts; one is on-demand SI procedure between remote UE and relay UE, the other one is SI acquires procedure of relay UE.
   Proposal 3: On-demand SI procedure should be introduced in PCS between remote UE and UE-to-Network relay.

Whether the relay UE needs to request the SI/SIB(s) requested by the remote UE from gNB depending on whether the relay UE has stored a valid version of the SI/SIB(s) requested by remote UE. If the relay UE has stored a valid version of the SI/SIB(s), it can directly forward it to the remote UE; otherwise, the relay UE can request the SI/SIB(s) from the gNB using legacy Uu procedure and then forward it to the remote UE. How to transmit the SI/SIB(s) on PC5 can be further discussed in WI phase.

Proposal 4: Relay UE acquires SI/SIB from the gNB using legacy Uu procedure.

The on-demand SI principles for remote UE can be summarized in proposal 5.

Proposal 5: on-demand SI principles for remote UE are as below:
On-demand SI request is supported for Remote UE for all RRC states (Idle/Inactive/Connected state).
On-demand SI procedure should be introduced in PCS between remote UE and UE-to-Network relay.
For Connected remote UE, on-demand SI in RRC_Connected that both SIB request and respond via dedicated signaling can be reused.
On-demand SI delivery is supported for the Remote UE(s) regardless of out-of-coverage or in-coverage, when connected with Relay UE.

In 3GPP TS 38.331 and TS 38.300, system information acquisition related procedure(s) and handling were introduced. Accordingly, a UE shall apply the System Information (SI) acquisition procedure as defined in 3GPP TS 38.331 upon cell selection (e.g. upon power on) or cell-reselection, return from out of coverage, after reconfiguration with sync completion, after entering the network from another Radio Access Technology (RAT), upon receiving an indication that the system information has changed, upon receiving a Public Warning System (PWS) notification, upon receiving request (e.g., a positioning request) from upper layers, and whenever the UE does not have a valid version of a stored System Information Block (SIB) or posSIB or a valid version of a requested SIB. On the other hand, when the UE acquires a MIB or a SIB1 or an SI message in a serving cell, and if the UE stores the acquired SIB, then the UE shall store the associated areaScope, the first PLMN-Identity, the cellIdentity, the systemInformationAreaID, and/or the valueTag for the SIB. Basically, the UE could check if a stored SIB is valid or not based on whether the first PLMN-Identity, the systemInformationAreaID, the cellIdentity and/or the valueTag for the SIB received from the serving cell are identical to the PLMN-Identity, the systemInformationAreaID, the cellIdentity and/or the valueTag associated with the stored version of that SIB. These parameters related to sidelink communication could be carried in e.g. SIB12.

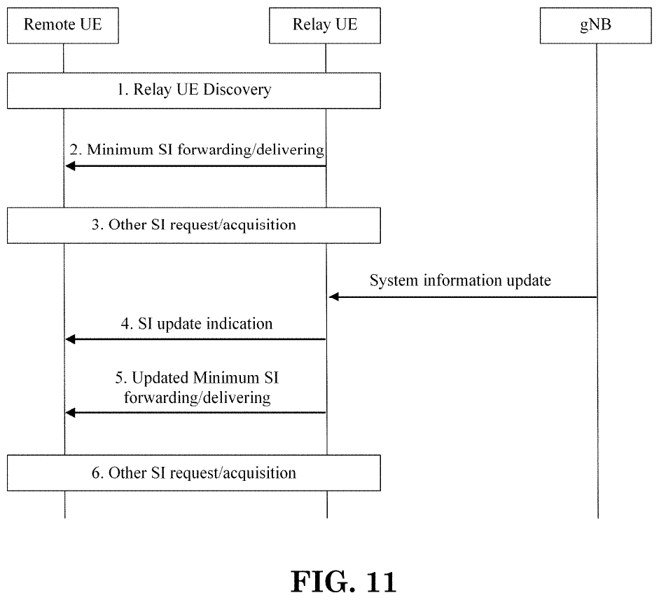

According to 3GPP TR 23.752 and R2-2008922, forwarding system information received from the serving cell of a Relay UE to a Remote UE (in RRC_IDLE or RRC_INACTIVE) could be supported in UE-to-Network relay communication. Thus, the step flow used for acquiring system information of a cell via a Relay UE locating at the cell could be considered and illustrated in FIG. 11 as follows:

Step 1. A Remote UE could find one or more Relay UEs based on received discovery messages sent by these found Relay UEs. And then, the Remote UE could select a Relay UE based on a relay UE selection criteria or procedure.

Step 2. Basically, each Relay UE could (periodically) broadcast the minimum SI (stored in this Relay UE) of the cell serving this Relay UE. The minimum SI could be sent via e.g. a PC5 RRC message. And then, the Remote UE could perform a SI acquisition procedure in order to acquire Minimum SI from the selected Relay UE. The Remote UE's lower layers could use a Layer-2 ID of the selected Relay UE as Source (Layer-2 or Layer-1) ID to monitor a sidelink control information used for scheduling a sidelink reception including Minimum SI of the selected Relay UE. The Remote UE's lower layers could use a common Layer-2 ID as Destination (Layer-2 or Layer-1) ID to monitor the sidelink control information used for scheduling a sidelink reception including Minimum SI of the selected Relay UE. The Remote UE could then receive a minimum SI forwarded by the selected Relay UE. The Remote UE could then store the minimum SI. The Layer-2 ID of the Relay UE could be found in the discovery message of the Relay UE. The Layer-2 ID of the Relay UE (or partial of the Layer-2 ID of the Relay UE, i.e. Layer-1 ID) could be used as a Source (Layer-2 or Layer-1) ID for sending/receiving the minimum SI. The common Layer-2 ID (or partial of the common Layer-2 ID, i.e. Layer-1 ID) could be used as a Destination (Layer-2 or Layer-1) ID for sending/receiving the minimum SI. The common Layer-2 ID could be associated with a purpose of delivering or forwarding system information. The common Layer-2 ID could be preconfigured or specified in the Remote UE and the Relay UE.

Step 3. According to the minimum SI, the Remote UE could send SI request to the Relay UE for acquiring Other SI. The Remote UE could generate a SI request message (e.g. RRCSystemInfoRequest) and deliver this SI request message to lower layer for transmission. Since the SI request message is to be sent to the Relay UE, the SI request message could be sent on a PC5 RLC bearer preconfigured or specified in the Remote UE. The SI request message could be sent based on the Layer-2 ID of the Relay UE (as Destination ID) and a Layer-2 ID of the Remote UE (as Source ID). The SI request message could be sent via e.g. PC5 RRC message. The Remote UE's lower layers could then use the Layer-2 ID of the selected Relay UE as Source (Layer-2 or Layer-1) ID and the Layer-2 ID of the Remote UE as Destination (Layer-2 or Layer-1) ID to monitor a sidelink control information used for scheduling a sidelink reception including Other SI of the selected Relay UE. Alternatively, the Remote UE's lower layers could then use the Layer-2 ID of the selected Relay UE as Source (Layer-2 or Layer-1) ID and the common Layer-2 ID as Destination (Layer-2 or Layer-1) ID to monitor a sidelink control information used for scheduling a sidelink reception including Other SI of the selected Relay UE. And then, the Remote UE could receive SIB(s) or SI message(s) as indicated in the SI request message from the Relay UE via e.g. PC5 RRC message. The Remote UE could then store the SIB(s) or SI message(s). The sidelink reception of the SIB(s) or SI message(s) could be indicated or scheduled by the sidelink control information used for scheduling a sidelink reception including Other SI of the selected Relay UE.

Step 4. Possibly, the Relay UE could receive an indication that the system information has been changed from gNB. Thus, the Relay UE could send or broadcast a sidelink control information used for indicating system information update. The Relay UE's lower layers could use the Layer-2 ID of the Relay UE as Source (Layer-2 or Layer-1) ID and the Layer-2 ID of the Remote UE as Destination (Layer-2 or Layer-1) ID to send the sidelink control information used for indicating system information update. Alternatively, the Relay UE's lower layers could use the Layer-2 ID of the Relay UE as Source (Layer-2 or Layer-1) ID and the common Layer-2 ID as Destination (Layer-2 or Layer-1) ID to send the sidelink control information used for indicating system information update.

Step 5. Similar to Step 2 discussed above, the Relay UE could then (periodically) broadcast the updated minimum SI. The Remote UE could then receive the updated minimum SI from the Relay UE.

Step 6. Similar to Step 3 discussed above, according to the updated minimum SI, the Remote UE could send SI request to the Relay UE for acquiring updated Other SI, if needed; and receive the updated SIB(s) or the updated SI message(s) from the Relay UE, if any.

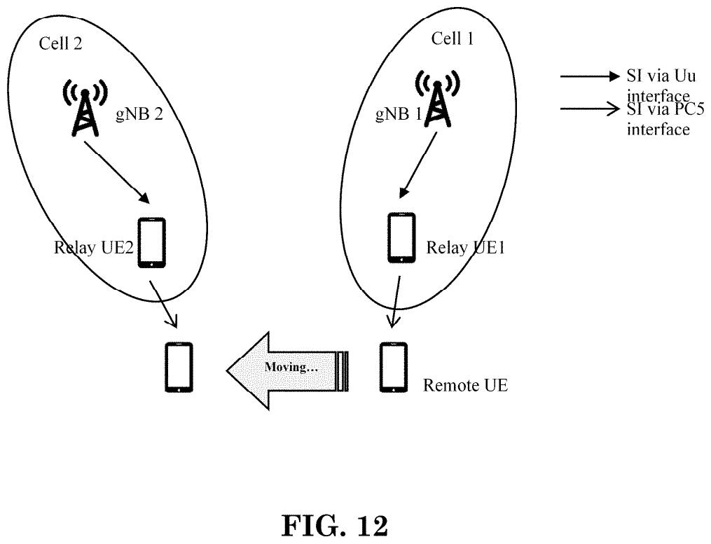

Since the Remote UE may move, the Remote UE would reselect another Relay UE according to relay UE selection criteria or procedure. It is possible that the new Relay UE's serving cell could be different from the old one's serving cell. This scenario could be illustrated in FIG. 12. Basically, parameters related to UE-to-Network relay communication could be provided in system information, and such parameters are different in different cells. In this situation, the Remote UE would need to perform the system information acquisition procedure to check if stored system information should be updated. Otherwise, the Remote UE cannot perform UE-to-Network relay communication with the Relay UE 2 which is in Cell 2 if the Remote UE still stores such parameters of Cell 1.

Possibly, the system information acquisition procedure specified in 3GPP TS 38.331 could be reused for the Remote UE. However, the Remote UE would not be able to perform the system information acquisition procedure since there is no condition for the Remote UE to trigger the system information acquisition procedure (when the Remote UE has selected the Relay UE but the Remote UE is out-of-coverage). Thus, it would be better for the Remote UE to perform the system information acquisition procedure when the current serving relay UE is changed or reselected.

More specifically, the Remote UE could perform system information acquisition procedure if or when a Relay UE is selected or reselected. The Remote UE could perform system information acquisition procedure upon selection or reselection of a Relay UE. The Remote UE could perform system information acquisition procedure in response to selection or reselection of a Relay UE.

More specifically, within the system information acquisition procedure, the Remote UE could monitor and/or receive a sidelink control information used for scheduling sidelink reception of Minimum SI from the Relay UE. This sidelink control information used for scheduling sidelink reception of Minimum SI could include a field indicating a Layer-2 ID or a Layer-1 ID (i.e. partial of the Layer-2 ID) of the Relay UE (as Source ID). This sidelink control information used for scheduling sidelink reception of Minimum SI could include a field indicating a common Layer-2 ID or a common Layer-1 ID (i.e. partial of the common Layer-2 ID) used for forwarding system information (as Destination ID). This sidelink control information used for scheduling sidelink reception of Minimum SI could include a field indicating the scheduled sidelink reception is for Minimum SI reception.

More specifically, within the system information acquisition procedure, the Remote UE could send a SI request message to the Relay UE. In the SI request message, the Remote UE could indicate which SIB or which SI message (including one or more SIBs) is required. The SI request message could be sent by using the Layer-2 ID or the Layer-1 ID of the Relay UE (as Destination ID). Alternatively, the SI request message could be sent by using the common Layer-2 ID or the common Layer-1 ID used for forwarding system information (as Destination ID). The SI request message could be sent by using the Layer-2 ID or the Layer-1 ID of the Remote UE (as Source ID). The Remote UE could send a sidelink control information used for scheduling sidelink transmission of the SI request message. The sidelink control information used for scheduling sidelink transmission of the SI request message could include a field indicating the Layer-2 ID or the Layer-1 ID of the Relay UE (as Destination ID). Alternatively, the sidelink control information used for scheduling sidelink transmission of the SI request message could include a field indicating the common Layer-2 ID or the common Layer-1 ID used for forwarding system information (as Destination ID). The sidelink control information used for scheduling sidelink transmission of the SI request message could include a field indicating the Layer-2 ID or the Layer-1 ID of the Remote UE (as Source ID). This sidelink control information used for scheduling sidelink transmission of the SI request message could include a field indicating the scheduled sidelink transmission is for SI request.

In response to reception of the SI request message, the Relay UE could send a sidelink control information used for scheduling sidelink reception for Other SI to the Remote UE. The sidelink reception for Other SI carries a transport block. The Relay UE could include one or more SIBs as requested by the Remote UE according to the SI request message in the transport block. Alternatively, the Relay UE could include one or more SI messages as requested by the Remote UE according to the SI request message in the transport block.

More specifically, within the system information acquisition procedure, the Remote UE could monitor and/or receive the sidelink control information used for scheduling sidelink reception of Other SI from the Relay UE. This sidelink control information used for scheduling sidelink reception of Other SI could include a field indicating the Layer-2 ID or the Layer-1 ID of the Relay UE (as Source ID). This sidelink control information used for scheduling sidelink reception of Other SI could include a field indicating the Layer-2 ID or the Layer-1 ID of the Remote UE (as Destination ID). Alternatively, this sidelink control information used for scheduling sidelink reception of Other SI could include a field indicating the common Layer-2 ID or the common Layer-1 ID used for forwarding system information (as Destination ID). This sidelink control information used for scheduling sidelink reception of Other SI could include a field indicating the scheduled sidelink reception is for Other SI reception.

More specifically, the sidelink control information used for indicating system information update could include a field indicating the Layer-2 ID or the Layer-1 ID of the Relay UE (as Source ID). The sidelink control information used for indicating system information update could include a field indicating the Layer-2 ID or the Layer-1 ID of the Remote UE (as Destination ID). Alternatively, the sidelink control information used for indicating system information update could include a field indicating the common Layer-2 ID or the common Layer-1 ID used for forwarding system information (as Destination ID). The sidelink control information used for indicating system information update could also include a field indicating the purpose of this sidelink control information is used for system information update.

The following exemplary text proposals for the invention could be proposed for 3GPP TS 38.331:

Text Proposal 1

### 5.2.2.2.1 SIB Validity

The UE shall apply the SI acquisition procedure as defined in clause 5.2.2.3 upon relay UE (re-) selection, upon cell selection (e.g. upon power on), cell-reselection, return from out of coverage, after reconfiguration with sync completion, after entering the network from another RAT, upon receiving an indication that the system information has changed, upon receiving a PWS notification, upon receiving request (e.g., a positioning request) from upper layers; and whenever the UE does not have a valid version of a stored SIB or posSIB or a valid version of a requested SIB.

Text Proposal 2

### 5.2.2.2.1 SIB Validity

The UE shall apply the SI acquisition procedure as defined in clause 5.2.2.3 upon selecting or reselecting a relay UE (in capable of supporting SI delivery), upon cell selection (e.g. upon power on), cell-reselection, return from out of coverage, after reconfiguration with sync completion, after entering the network from another RAT, upon receiving an indication that the system information has changed, upon receiving a PWS notification, upon receiving request (e.g., a positioning request) from upper layers; and whenever the UE does not have a valid version of a stored SIB or posSIB or a valid version of a requested SIB.

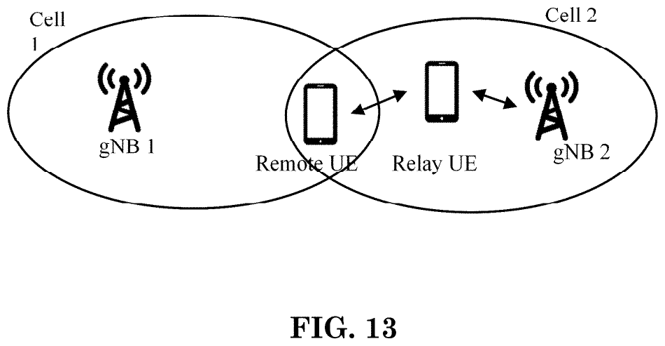

According to 3GPP R2-2008922, on-demand SI delivery could be supported for Relay UE and Remote UE they are in different cells. Different cells could belong to different areas. It is possible that the Remote UE could locate at a first cell (belonging to a system information area) and the Relay UE could locate at a second cell (belonging to the system information area or another system information area). It is supposed that the Remote UE firstly camps on the first cell and then selects the Relay UE later. This scenario could be illustrated in FIG. 13.

According to 3GPP TS 38.331, the system information acquisition procedure would be triggered upon receiving an indication that the system information has changed. In this case, the Remote UE will be triggered to perform a system information acquisition procedure to acquire system information from the first cell that is not necessary since the Remote UE has already selected the Relay UE for acquiring system information (of the second cell). Therefore, to address this situation, it is proposed that the Remote UE could determine whether to perform a system information acquisition procedure for acquiring system information from a cell based on whether the Remote UE has selected a Relay UE (for acquiring system information from this Relay UE), upon receiving an indication about system information update from the cell. If the Remote UE has selected or reselected a Relay UE and it receives the indication about system information update from a cell, the Remote UE could ignore this indication and does not perform the system information acquisition procedure for acquiring system information from the cell. If the Remote UE does not find any Relay UE or there is no proper Relay UE can be selected, the Remote UE could still perform the system information acquisition procedure for acquiring system information from the cell. The above concept could be also applied for the case of receiving a PWS notification that also triggers the system information acquisition procedure for acquiring system information from serving cell.

The following exemplary text proposal for the invention could be proposed for 3GPP TS 38.331:

Text Proposal

### 5.2.2.2.1 SIB Validity

The UE shall apply the SI acquisition procedure as defined in clause 5.2.2.3 upon cell selection (e.g. upon power on), cell-reselection, return from out of coverage, after reconfiguration with sync completion, after entering the network from another RAT, upon receiving an indication that the system information has changed and no relay UE (in capable of supporting SI delivery) is selected, upon receiving a PWS notification and no relay UE (in capable of supporting SI delivery) is selected, upon receiving request (e.g., a positioning request) from upper layers; and whenever the UE does not have a valid version of a stored SIB or posSIB or a valid version of a requested SIB.

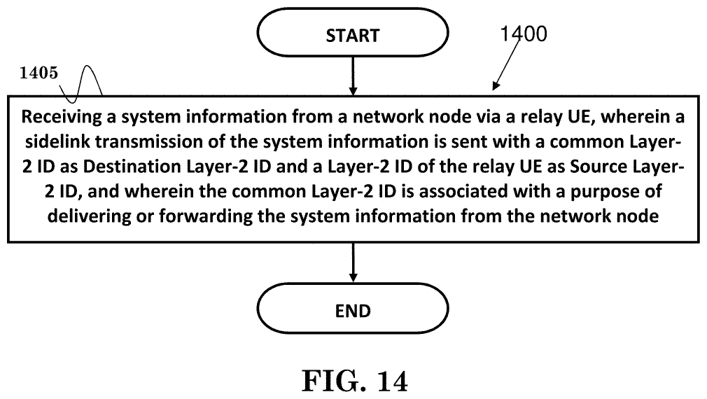

FIG. 14 is a flow chart 1400 illustrating a method for a remote UE to receive system information. In step 1405, the remote UE receives a system information from a network node via a relay UE, wherein a sidelink transmission of the system information is sent with a common Layer-2 Identity (ID) as Destination Layer-2 ID and a Layer-2 ID of the relay UE as Source Layer-2 ID, and wherein the common Layer-2 ID is associated with a purpose of delivering or forwarding the system information from the network node.

In one embodiment, the system information may be a minimum or essential system information broadcasted by the network node. The Layer-2 ID of the relay UE may be known to the remote UE by receiving a discovery message from the relay UE.

In one embodiment, the common Layer-2 ID associated with the purpose of delivering or forwarding the system information could be preconfigured or specified in the remote UE. The network node may be a gNB or a base station.

Referring back to FIGS. 3 and 4, in one exemplary embodiment of a method for a remote UE to receive system information, the remote UE 300 includes a program code 312 stored in the memory 310. The CPU 308 could execute program code 312 to enable the remote UE to receive a system information from a network node via a relay UE, wherein a sidelink transmission of the system information is sent with a common Layer-2 ID as Destination Layer-2 ID and a Layer-2 ID of the relay UE as Source Layer-2 ID, and wherein the common Layer-2 ID is associated with a purpose of delivering or forwarding the system information from the network node. Furthermore, the CPU 308 can execute the program code 312 to perform all of the above-described actions and steps or others described herein.

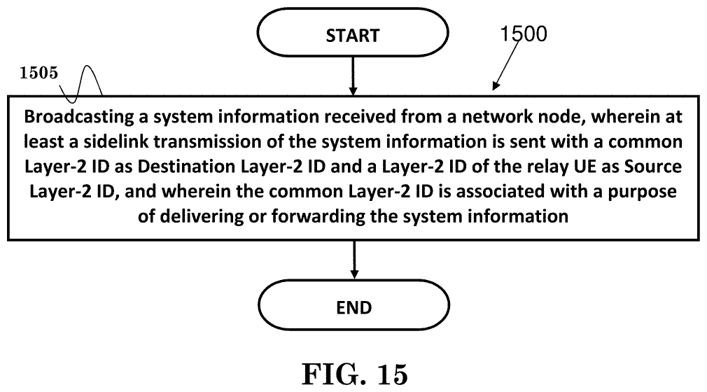

FIG. 15 is a flow chart 1500 illustrating a method for a relay UE to transmit or deliver system information. In step 1505, the relay UE broadcasts a system information received from a network node, wherein at least a sidelink transmission of the system information is sent with a common Layer-2 ID as Destination Layer-2 ID and a Layer-2 ID of the relay UE as Source Layer-2 ID, and wherein the common Layer-2 ID is associated with a purpose of delivering or forwarding the system information.

In one embodiment, the system information may be a minimum or essential system information broadcasted by the network node. The relay UE could broadcast or transmit at least a discovery message, wherein the discovery message is sent with the Layer-2 ID of the relay UE.

In one embodiment, the common Layer-2 ID associated with the purpose of delivering or forwarding the system information could be preconfigured or specified in the relay UE. The network node may be a gNB or a base station.

Referring back to FIGS. 3 and 4, in one exemplary embodiment of a method for a relay UE to transmit or deliver system information, the relay UE 300 includes a program code 312 stored in the memory 310. The CPU 308 could execute program code 312 to enable the relay UE to broadcast a system information received from a network node, wherein at least a sidelink transmission of the system information is sent with a common Layer-2 ID as Destination Layer-2 ID and a Layer-2 ID of the relay UE as Source Layer-2 ID, and wherein the common Layer-2 ID is associated with a purpose of delivering or forwarding the system information. Furthermore, the CPU 308 can execute the program code 312 to perform all of the above-described actions and steps or others described herein.

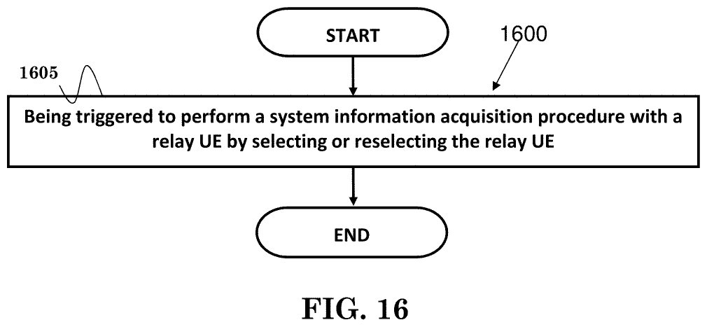

FIG. 16 is a flow chart 1600 illustrating a method for a remote UE to acquire system information of one cell from one relay UE. In step 1605, the remote UE is being triggered to perform a system information acquisition procedure with a relay UE by selecting or reselecting the relay UE.

In one embodiment, the remote UE could receive a first message from the relay UE in the system information acquisition procedure, wherein the first message includes a minimum system information of a cell serving the relay UE. The remote UE could transmit a second message to the relay UE in the system information acquisition procedure, wherein the second message indicates at least a System Information Block (SIB) or a SI message is requested by the remote UE. The remote UE could receive a third message from the relay UE in the system information acquisition procedure, wherein the third message includes the SIB or the SI message as requested by the remote UE.

In one embodiment, the first/second/third message may be a PC5 Radio Resource Control (RRC) message.

Referring back to FIGS. 3 and 4, in one exemplary embodiment of a method for a remote UE to acquire system information of one cell from one relay UE, the remote UE 300 includes a program code 312 stored in the memory 310. The CPU 308 could execute program code 312 to enable the remote UE to be triggered to perform a system information acquisition procedure with a relay UE by selecting or reselecting the relay UE. Furthermore, the CPU 308 can execute the program code 312 to perform all of the above-described actions and steps or others described herein.

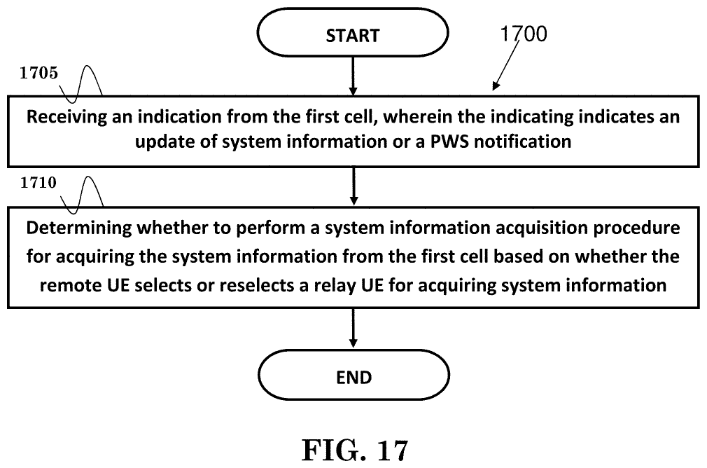

FIG. 17 is a flow chart 1700 illustrating a method for a remote UE in a first cell to acquire system information. In step 1705, the remote UE receives an indication from the first cell, wherein the indicating indicates an update of system information or a PWS notification. In step 1710, the remote UE determines whether to perform a system information acquisition procedure for acquiring the system information from the first cell based on whether the remote UE selects or reselects a relay UE for acquiring system information.

In one embodiment, the remote UE could perform the system information acquisition procedure for acquiring the system information from the first cell if the remote UE does not select any relay UE for acquiring system information. The remote UE may not perform the system information acquisition procedure for acquiring the system information from the first cell if the remote UE selects or reselects the relay UE for acquiring system information.

In one embodiment, the remote UE could perform the system information acquisition procedure for acquiring the system information from the first cell with a base station (e.g. gNB of the first cell). The remote UE could perform a second system information acquisition procedure for acquiring system information from the relay UE if the remote UE selects or reselects the relay UE for acquiring system information. The remote UE could perform the second system information acquisition procedure for acquiring the system information from the relay UE with the relay UE.

In one embodiment, the system information received from the relay UE could belong to a second cell.

In one embodiment, the indication could be sent via a paging message. the indication is sent by the base station.

Referring back to FIGS. 3 and 4, in one exemplary embodiment of a method for a remote UE in a first cell to acquire system information, the remote UE 300 includes a program code 312 stored in the memory 310. The CPU 308 could execute program code 312 to enable the remote UE (i) to receive an indication from the first cell, wherein the indicating indicates an update of system information or a PWS notification, and (ii) to determine whether to perform a system information acquisition procedure for acquiring the system information from the first cell based on whether the remote UE selects or reselects a relay UE for acquiring system information. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a remote User Equipment (UE) to receive system information, comprising:
receiving a system information from a network node via a relay UE, wherein a sidelink transmission of the system information is sent with a common Layer-2 Identity (ID) as Destination Layer-2 ID and a Layer-2 ID of the relay UE as Source Layer-2 ID, and wherein the common Layer-2 ID is associated with a purpose of delivering or forwarding the system information from the network node.

2. The method of claim 1, wherein the system information is a minimum or essential system information broadcasted by the network node.

3. The method of claim 1, wherein the Layer-2 ID of the relay UE is known to the remote UE by receiving a discovery message from the relay UE.

4. The method of claim 1, wherein the common Layer-2 ID associated with the purpose of delivering or forwarding the system information is preconfigured or specified in the remote UE.

5. The method of claim 1, wherein the network node is a gNB or a base station.

6. A method for a relay User Equipment (UE) to transmit or deliver system information, comprising:
broadcasting a system information received from a network node, wherein at least a sidelink transmission of the system information is sent with a common Layer-2 Identity (ID) as Destination Layer-2 ID and a Layer-2 ID of the relay UE as Source Layer-2 ID, and wherein the common Layer-2 ID is associated with a purpose of delivering or forwarding the system information.

7. The method of claim 6, wherein the system information is a minimum or essential system information broadcasted by the network node.

8. The method of claim 6, further comprising:
broadcasting or transmitting at least a discovery message, wherein the discovery message is sent with the Layer-2 ID of the relay UE.

9. The method of claim 6, wherein the common Layer-2 ID associated with the purpose of delivering or forwarding the system information is preconfigured or specified in the relay UE.

10. The method of claim 6, wherein the network node is a gNB or a base station.

11. A relay User Equipment (UE) to transmit or deliver system information, comprising:
a control circuit;
a processor installed in the control circuit; and
a memory installed in the control circuit and operatively coupled to the processor;
wherein the processor is configured to execute a program code stored in the memory to:
broadcast a system information received from a network node, wherein at least a sidelink transmission of the system information is sent with a common Layer-2 Identity (ID) as Destination Layer-2 ID and a Layer-2 ID of the relay UE as Source Layer-2 ID, and wherein the common Layer-2 ID is associated with a purpose of delivering or forwarding the system information.

12. The relay UE of claim 11, wherein the system information is a minimum or essential system information broadcasted by the network node.

13. The relay UE of claim 11, further comprising:
broadcasting or transmitting at least a discovery message, wherein the discovery message is sent with the Layer-2 ID of the relay UE.

14. The relay UE of claim 11, wherein the common Layer-2 ID associated with the purpose of delivering or forwarding the system information is preconfigured or specified in the relay UE.

15. The relay UE of claim 11, wherein the network node is a gNB or a base station.
